(19) United States
(12) Patent Application Publication
(10) Pub. No.: US 2012/0003888 A1
(43) Pub. Date: Jan. 5, 2012

(54) BIOADHESIVE CONSTRUCTS WITH POLYMER BLENDS

(75) Inventors: Bruce P. Lee, Madison, WI (US); Jeffrey L. Dalsin, Verona, WI (US); Laura Vollenweider, Lodi, WI (US); John L. Murphy, Verona, WI (US); Fangmin Xu, Sudbury, MA (US)

(73) Assignee: KNC NER ACQUISITION SUB, INC., Wilmington, DE (US)

(21) Appl. No.: 13/148,283

(22) PCT Filed: Feb. 5, 2010
(86) PCT No.: PCT/US10/23382

§ 371 Date: Sep. 13, 2011

Related U.S. Application Data
(60) Provisional application No. 61/150,483, filed on Feb. 6, 2009.

(51) Int. Cl. C09J 7/04; C09J 7/02; C08L 77/00

(52) U.S. Cl. 442/1; 525/434; 523/118; 428/355 R; 442/149

(57) ABSTRACT

The invention describes substrates, such as prosthetics, films, nonwovens, meshes, etc. that are treated with a bioadhesive polymer blend. The bioadhesive includes polymeric substances that have phenyl moieties with at least two hydroxyl groups. The bioadhesive blend constructs can be used to treat and repair, for example, hernias and damaged tendons.

### CROSS REFERENCE TO RELATED APPLICATIONS

This application claims priority to U.S. Provisional Patent Application Ser. No. 61/150,483 filed Feb. 6, 2009, which is herein incorporated by reference in its entirety.

### REFERENCE TO FEDERAL FUNDING

The project was funded in part by NIH (1R43AR056519-01A1, 1R43DK083199-01, and 2 R44DK083199-02), and NSF (IIP-0912221) grants. NMR characterization was performed at NMRFAM, which is supported by NIH (P41RR02301, P41GM66326, P41GM66326, P41RR02301, RR02781, RR08438) and NSF (DMB-8415048, OIA-9977486, BIR-9214394) grants. The government has certain rights in the invention.

### FIELD OF THE INVENTION

The invention relates generally various substrates, such as prosthetics, films, nonwovens, meshes, etc. that are treated with a bioadhesive blend. The bioadhesive includes polymeric substances that have phenyl moieties with at least two hydroxyl groups. The polymeric component can be a polymer that helps modify the viscosity, hydrophilic or hydrophobic properties of the resultant composition. The blends can be used to treat and repair, for example, wounds and the like.

### BACKGROUND OF THE INVENTION

Mussel adhesive proteins (MAPs) are remarkable underwater adhesive materials secreted by certain marine organisms which form tenacious bonds to the substrates upon which they reside. During the process of attachment to a substrate, MAPs are secreted as adhesive fluid precursors that undergo a crosslinking or hardening reaction which leads to the formation of a solid adhesive plaque. One of the unique features of MAPs is the presence of L-3-4-dihydroxyphenylalanine (DOPA), an unusual amino acid which is believed to be responsible for adhesion to substrates through several mechanisms that are not yet fully understood. The observation that mussels adhere to a variety of surfaces in nature (metal, metal oxide, polymer) led to a hypothesis that DOPA-containing peptides can be employed as the key components of synthetic medical adhesives or coatings.

For example, bacterial attachment and biofilm formation are serious problems associated with the use of urinary stents and catheters as they often lead to chronic infections that cannot be resolved without removing the device. Although numerous strategies have been employed to prevent these events including the alteration of device surface properties, the application of anti-attachment and antibacterial coatings, host dietary and urinary modification, and the use of therapeutic antibiotics, no one approach has yet proved completely effective. This is largely due to three important factors, namely various bacterial attachment and antimicrobial resistance strategies, surface masking by host urinary and bacterial constituents, and biofilm formation. While the urinary tract has multiple anti-infective strategies for dealing with invading microorganisms, the presence of a foreign stent or catheter provides a novel, non-host surface to which they can attach and form a biofilm. This is supported by studies highlighting the ability of normally non-uropathogenic microorganisms to readily cause device-associated urinary tract infections. Ultimately, for a device to be clinically successful it must not only resist bacterial attachment but that of urinary constituents as well. Such a device would better allow the host immune system to respond to invading organisms and eradicate them from the urinary tract.

For example, bacterial attachment and subsequent infection and encrustation of uropathogenic E. coli (UPEC) cystitis is a serious condition associated with biofouling. Infections with E. coli comprise over half of all urinary tract device-associated infections, making it the most prevalent pathogen in such episodes.

Additionally, in the medical arena, few adhesives exist which provide both robust adhesion in a wet environment and suitable mechanical properties to be used as a tissue adhesive or sealant. For example, fibrin-based tissue sealants (e.g. Tisseel VH, Baxter Healthcare) provide a good mechanical match for natural tissue, but possess poor tissue-adhesion characteristics. Conversely, cyanoacrylate adhesives (e.g. Dermabond, ETHICON, Inc.) produce strong adhesive bonds with surfaces, but tend to be stiff and brittle in regard to mechanical properties and tend to release formaldehyde as they degrade.

Therefore, a need exists for materials that overcome one or more of the current disadvantages.

### BRIEF SUMMARY OF THE INVENTION

The present invention surprisingly provides unique bioadhesive blends that can be used in constructs that are suitable to repair or reinforce damaged tissue.

The constructs include a suitable support that can be formed from a natural material, such as collagen or man made materials such as polypropylene and the like. The support can be a film, a membrane, a mesh, a non-woven and the like. The support need only help provide a surface for the bioadhesive to adhere. The support should also help facilitate physiological reformation of the tissue at the damaged site. Thus the constructs of the invention provide a site for remodeling via fibroblast migration, followed by subsequent native collagen deposition.

The bioadhesive is any polymer that includes multihydroxy phenyl groups, referred to herein a DHPD's. The polymer backbone can be virtually any material as long as the polymer contains DHPD's that are tethered to the polymer via a linking group or a linker. Generally, the DHPD comprises at least about 1 to 100 weight percent of the polymer (DHPp), more particularly at least about 2 to about 65 weight percent of the DHPp and even more particularly, at least about 3 to about 55 weight percent of the DHPp. Suitable materials are discussed throughout the specification.

In certain embodiments an oxidant is included with the bioadhesive film layer. The oxidant can be incorporated into the polymer film or it can be contacted to the film at a later time. In either situation, the oxidant upon activation, can help promote crosslinking of the multihydroxy phenyl groups with each other and/or tissue. Suitable oxidants include periodates and the like.

The invention further provides crosslinked bioadhesive constructs derived from the compositions described herein. For example, two DHDP moieties from two separate polymer chains can be reacted to form a bond between the two DHDP moieties. Typically, this is an oxidative/radical initiated crosslinking reaction wherein oxidants/initiators such as NaIO₃, NaIO₄, FeCl₃, H₂O₂, oxygen, an inorganic base, an organic base or an enzymatic oxidase can be used. Typically, a ratio of oxidant/initiator to DHDP containing material is between about 0.2 to about 1.0 (on a molar basis) (oxidant:DHDP). In one particular embodiment, the ratio is between about 0.25 to about 0.75 and more particularly between about 0.4 to about 0.6 (e.g., 0.5). It has been found that periodate is very effective in the preparation of crosslinked hydrogels of the invention.

Typically, when the DHDP containing construct is treated with an oxidant/initiator as described herein, the coating gels (crosslinks) within 1 minute, more particularly within 30 seconds, most particularly under 5 seconds and in particular within 2 seconds or less.

The use of the bioadhesive constructs eliminates or reduces the need to use staples, sutures, tacks and the like to secure or repair damaged tissue, for example, such as herniated tissue or torn ligaments or tendons.

The bioadhesive constructs of the invention combine the unique adhesive properties of multihydroxy (dihydroxyphenyl)-containing polymers with the biomechanical properties, bioinductive ability, and biodegradability of biologic meshes to develop a novel medical device for hernia repair. A thin film of biodegradable, water-resistant adhesive will be coated onto a commercially available, biologic mesh to create an adhesive bioprosthesis. These bioadhesive prosthetics can be affixed over a hernia site without sutures or staples, thereby potentially preventing tissue and nerve damage at the site of the repair. Both the synthetic glue and the biologic meshes are biodegradable, and will be reabsorbed when the mechanical support of the material is no longer needed; these compounds prevent potential long-term infection and chronic patient discomfort typically associated with permanent prosthetic materials. Additionally, minimal preparation is required for the proposed bioadhesive prosthesis, which can potentially simplify surgical procedures. The adhesive coating will be characterized, and both adhesion tests and mechanical tests will be performed on the bioadhesive biologic mesh to determine the feasibility of using such a material for hernia repair.

Additionally, the unique adhesive properties of dihydroxyphenyl-containing polymers can be combined with the biomechanical properties, bioinductive ability, and biodegradability of a collagen membrane to develop a novel augmentation device for tendon and ligament repair. These bioadhesive tapes can be wrapped around or placed over a torn tendon or ligament to create a repair stronger than sutures alone. This new method of augmentation supports the entire graft surface by adhering to the tissue being repaired, as opposed to conventional repair methods, which use sutures to attach the graft at only a few points. Securing the repaired tissue more effectively means that patients can potentially begin post-operative rehabilitation much sooner, a critical development, as early mobilization has been found to be crucial for regenerating well organized and functional collagen fibers in tendons and ligaments. The collagen membranes will be coated with biomimetic synthetic adhesive polymers (described herein) to create a bioadhesive collagen tape. The adhesive coating will be characterized, and both adhesion and mechanical tests will be performed on the bioadhesive collagen tape to determine the feasibility of using such a material to augment tendon and ligament repair.

The compounds of the invention can be applied to a suitable substrate surface as a film or coating. Application of the compound(s) to the surface inhibits or reduces the growth of biofilm (bacteria) on the surface relative to an untreated substrate surface. In other embodiments, the compounds of the invention can be employed as an adhesive.

Exemplary applications include, but are not limited to fixation of synthetic (resorbable and non-resorbable) and biological membranes and meshes for hernia repair, void-eliminating adhesive for reduction of post-surgical seroma formation in general and cosmetic surgeries, fixation of synthetic (resorbable and non-resorbable) and biological membranes and meshes for tendon and ligament repair, sealing incisions after ophthalmic surgery, sealing of venous catheter access sites, bacterial barrier for percutaneous devices, as a contraceptive device, a bacterial barrier and/or drug depot for oral surgeries (e.g. tooth extraction, tonsillectomy, cleft palate, etc.), for articular cartilage repair, for antifouling or anti-bacterial adhesion.

In one embodiment, the reaction products of the syntheses described herein are included as compounds or compositions useful as adhesives or surface treatment/antifouling aids. It should be understood that the reaction product(s) of the synthetic reactions can be purified by methods known in the art, such as diafiltration, chromatography, recrystallization/precipitation and the like or can be used without further purification.

It should be understood that the compounds of the invention can be coated multiple times to form bi, tri, etc. layers. The layers can be of the compounds of the invention per se, or of blends of a compound(s) and polymer, or combinations of a compound layer and a blend layer, etc.

Consequently, constructs can also include such layering of the compounds per se, blends thereof, and/or combinations of layers of a compound(s) per se and a blend or blends.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### BRIEF DESCRIPTION OF THE DRAWINGS

FIG. 1 provides exemplary DHPp molecules that can be used herein.

### DETAILED DESCRIPTION

In the specification and in the claims, the terms “including” and “comprising” are open-ended terms and should be interpreted to mean “including, but not limited to . . . .” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

General Applications

The bioadhesive constructs described herein can be used to repair torn, herniated, or otherwise damaged tissue. The tissue can vary in nature but includes cardiovascular, vascular, epithelial, ligament, tendon, muscle, bone and the like. The constructs can be utilized with general surgical techniques or with more advanced laparoscopic techniques. Once the constructs are applied to the damaged/injured site, they can be directly adhered to the tissue. Alternatively and in addition to the adherence of the adhesive to the tissue, staples, sutures or tacks and the like can also be used to help secure the construct.

In addition to tendon and ligament repair and hernia repair, the bioadhesive construct could potentially be utilized in cardiovascular surgery. Over 600,000 vascular grafts are implanted annually to replace damaged blood vessels. Coronary artery bypass grafting (CABG) is the most common method of replacing diseased blood vessels. When no suitable autologous vessels are available, there are several synthetic materials used for prosthetic vascular grafts such as PTFE, polyurethane and Dacron. Such materials have been used in cardiovascular repair since the early 1950's. In addition to synthetic grafts, collagen has been investigated with some success for use as a cardiovascular graft material, especially in large diameter vessels. Regardless of the graft material used, sutures are almost always used to secure the graft to the existing tissue. Disadvantages of using sutures are that it takes the surgeon a considerable amount of time and that there is the potential of the sutures tearing through the graft material.

Another potential application for the current invention is dental implants. Collagen membranes (Biomend®) have also been utilized in guided bone regeneration (GBR) to promote implant wound healing in clinical periodontics. Materials used in GBR are either placed over the defect followed by wound closure, or can be sutured in place prior to wound closure. Adhesive collagen membranes could reduce surgery time and simplify the process of securing the membrane.

In addition to using the biomimetic glue as a method of prosthesis fixation, the adhesive can be applied as a sealant to prevent leakage of blood in cardiovascular repair. Furthermore, the present adhesives are constructed with predominately PEG-based polymers, which are widely known for their antifouling properties. Once the catechol undergoes oxidative crosslinking with the tissue substrate or during curing of the adhesive, the biomimetic adhesive loses its adhesive properties and becomes a barrier for bacterial adhesion or tissue adhesion.

The bioadhesive constructs of the invention can be used to repair the entrance portal in annulus fibrosis used for insertion of nucleus fibrosis replacement; prevent extrusion of implant by patch fixation. The constructs can also be used for the repair of annulus fibrosis in herniated disc or after discectomy by patch fixation.

The bioadhesive constructs can be used as a barrier for bone graft containment in posterior fusion procedures. This provides containment around bone graft material either by patching in place, or by pre-coating a containment patch with the bioadhesive (“containment adhesive bandage”) and then applying.

The bioadhesive constructs of the invention can be used to treat stress fractures.

The bioadhesive constructs of the invention can be used to repair lesions in avascular portion of knee meniscus. A construct can be used to stabilize a meniscal tear and connect the avascular region with vascular periphery to encourage ingrowth of vascularity and recruitment of meniscal progenitor cells. Current techniques lead to repair with weak non-meniscal fibrous scar tissue. The bioadhesive patch may also serve as vehicle for delivery of growth factors and progenitor cells to enhance meniscus repair.

In certain embodiments the bioadhesive constructs of the invention can be referred to as a “patch”. In other embodiments, the bioadhesive constructs can be referred to as a “tape”. In any event, the bioadhesive constructs include a bioadhesive layer and a support material.

Bioadhesives

Suitable materials that can serve as bioadhesives useful to prepare the constructs of the invention include those described in 60/910,683 filed on Apr. 9, 2007, entitled “DOPA-Functionalized, Branched, Poly(ethylene-Glycol) Adhesives”, by Sean A. Burke, Jeffrey L. Dalsin, Bruce P. Lee and Phillip B. Messersmith, U.S. Ser. No. 12/099,254, filed Apr. 8, 2008, entitled “DOPA-Functionalized, Branched, Poly(ethylene-Glycol) Adhesives”, by Sean A. Burke, Jeffrey L. Dalsin, Bruce P. Lee and Phillip B. Messersmith, U.S. Ser. No. 11/676,099, filed Feb. 16, 2007, entitled “Modified Acrylic Block Copolymers for Hydrogels and Pressure Sensitive Wet Adhesives”, by Kenneth R. Shull, Murat Guvendiren, Phillip B. Messermsith and Bruce P. Lee and U.S. Ser. No. 11/834,651, filed Aug. 6, 2007, entitled “Biomimetic Compounds and Synthetic Methods Therefor”, by Bruce P. Lee, the contents of which are incorporated in their entirety herein by reference including any provisional applications referred to therein for a priority date(s) for all purposes.

“Monomer” as the term is used herein to mean non-repeating compound or chemical that is capable of polymerization to form a pB.

“Prepolymer” as the term is used herein to mean an oligomeric compound that is capable of polymerization or polymer chain extension to form a pB. The molecular weight of a prepolymer will be much lower than, on the order of 10% or less of, the molecular weight of the pB.

Monomers and prepolymers can be and often are polymerized together to produce a pB.

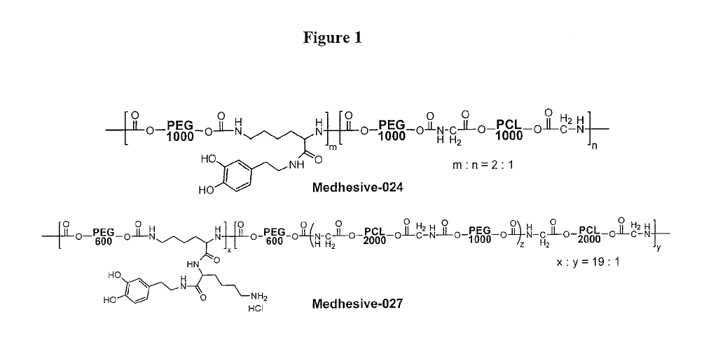

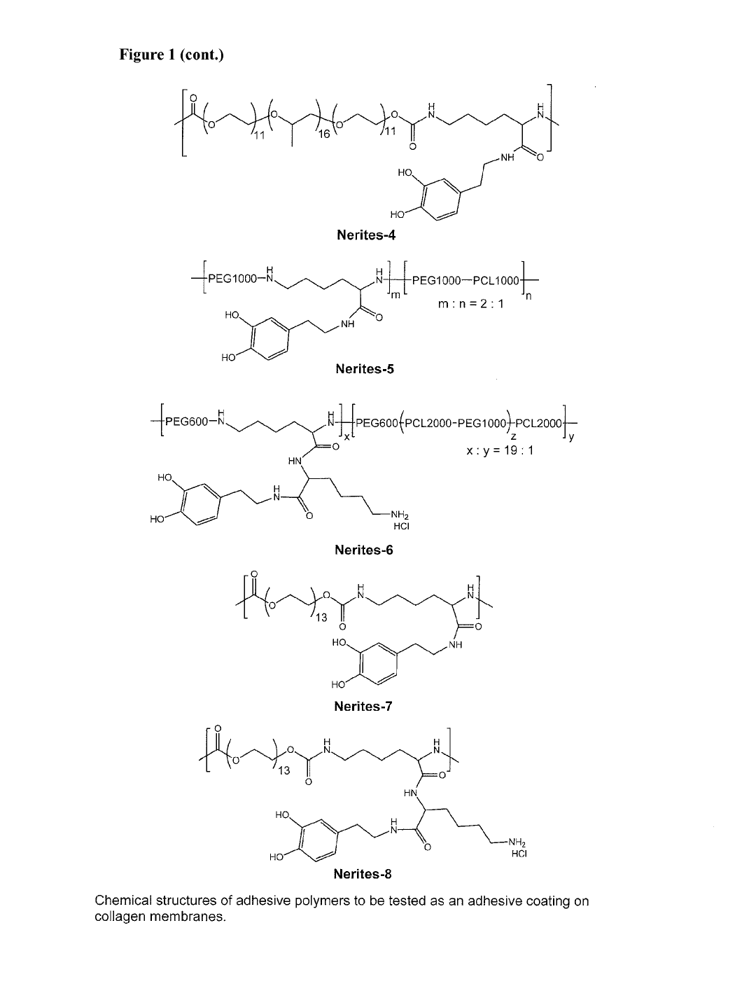

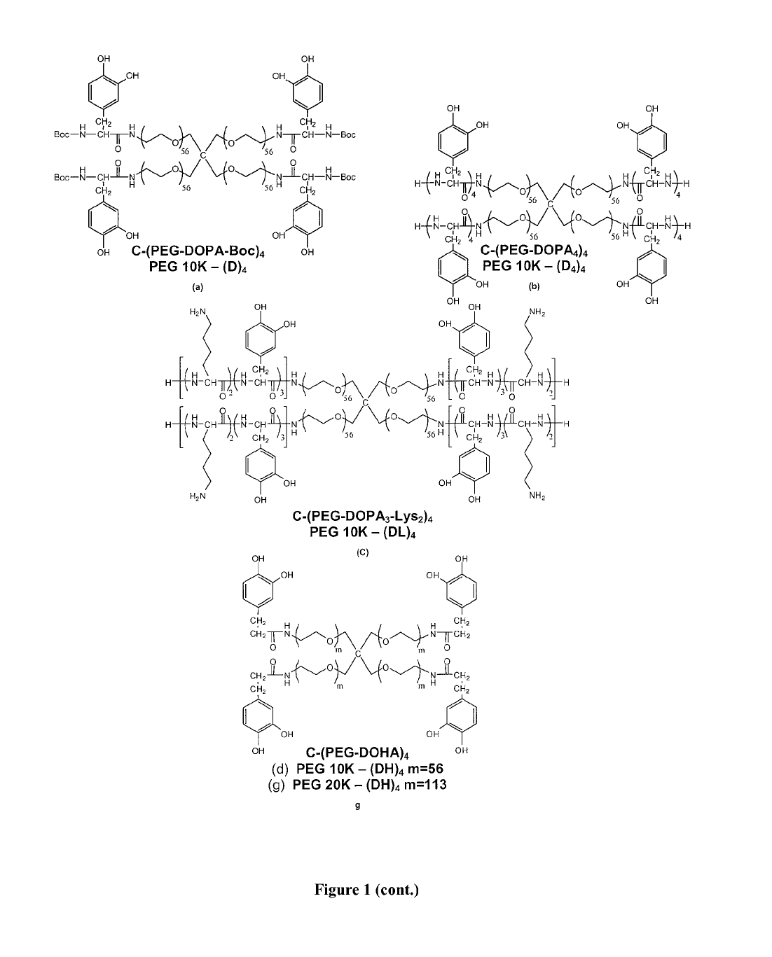

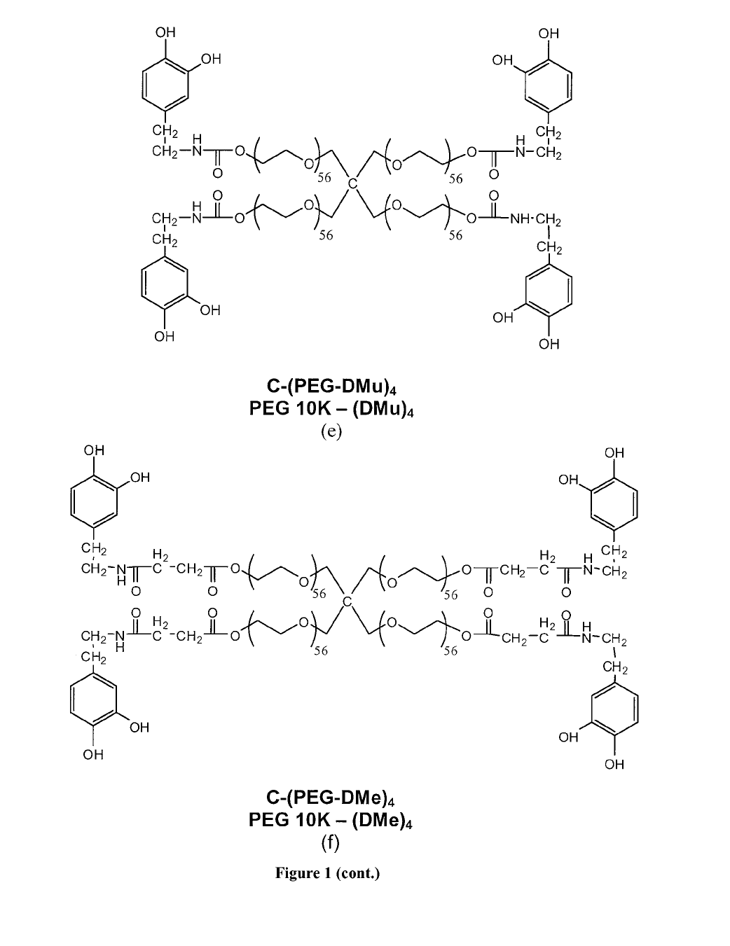

“pB” as the term is used herein to mean a polymer backbone comprising a polymer, co-polymer, terpolymer, oligomer or multi-mer resulting from the polymerization of pB monomers, pB prepolymers, or a mixture of pB monomers and/or prepolymers. The polymer backbone is preferably a homopolymer but most preferably a copolymer. The polymer backbone is DHPp excluding DHPD. Exemplary DHPp polymers are depicted in FIG. 1.

pB is preferably polyether, polyester, polyamide, polyurethane, polycarbonate, or polyacrylate among many others and the combination thereof.

pB can be constructed of different linkages, but is preferably comprised of acrylate, carbon-carbon, ether, amide, urea, urethane, ester, or carbonate linkages or a combination thereof to achieve the desired rate of degradation or chemical stability.

pB of desired physical properties can be selected from prefabricated functionalized polymers or FP, a pB that contain functional groups (i.e. amine, hydroxyl, thiol, carboxyl, vinyl group, etc.) that can be modified with DHPD to from DHPp.

The actual method of linking the monomer or prepolymer to form a pB will result in the formation of amide, ester, urethane, urea, carbonate, or carbon-carbon linkages or the combination of these linkages, and the stability of the pB is dependent on the stability of these linkages.

“FP” as the term is used herein to mean a polymer backbone functionalized with amine, thiol, carboxy, hydroxyl, or vinyl groups, which can be used to react with DHPD to form DHPp, for example.

“DHPD weight percent” as the term is used herein to mean the percentage by weight in DHPp that is DHPD.

“DHPp molecular weight” as the term is used herein to mean the sum of the molecular weights of the polymer backbone and the DHPD attached to said polymer backbone.

In one aspect, the polymer comprises the formula

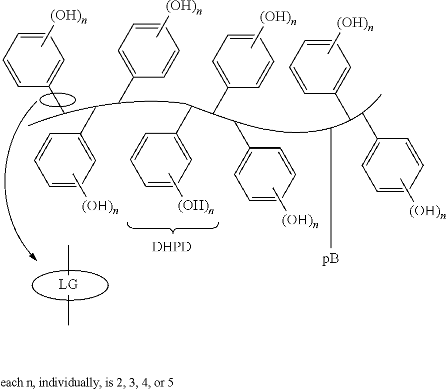

wherein LG is an optional linking group or linker, DHPD is a multihydroxyphenyl group, each n, individually, is 2, 3, 4 or 5, and pB is a polymeric backbone.

In another aspect, the polymer comprises the formula:

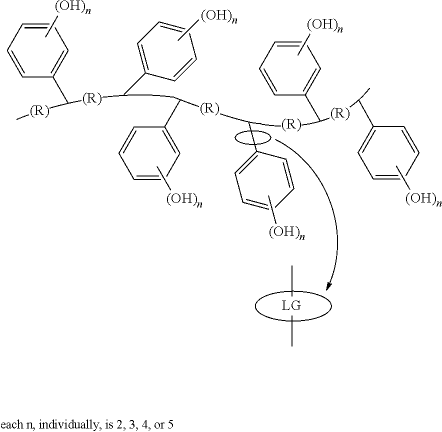

wherein R is a monomer or prepolymer linked or polymerized to form pB, pB is a polymeric backbone, LG is an optional linking group or linker and each n, individually, is 2, 3, 4 or 5.

In another aspect, the present invention provides a multi-armed, poly (alkylene oxide) polyether, multihydroxy (dihydroxy)phenyl derivative (DHPD) having the general formula:

CA-[Z-PA-(L)ₐ-(DHPD)_{b}-(AA)_{c}-PG]ₙ

wherein

CA is a central atom selected from carbon, oxygen, sulfur, nitrogen, or a secondary amine, most particularly a carbon atom;

each Z, independently, is a C1 to a C6 linear or branched, substituted or unsubstituted alkyl group or a bond;

each PA, independently, is a substantially poly(alkylene oxide) polyether or derivative thereof;

each L, independently, optionally, is a linker or is a linking group selected from amide, ester, urea, carbonate or urethane linking groups;

each DHPD, independently is a multihydroxy phenyl derivative;

each AA, independently, optionally, is an amino acid moiety,

each PG, independently, is an optional protecting group, and if the protecting group is absent, each PG is replaced by a hydrogen atom;

“a” has a value of 0 when L is a linking group or a value of 1 when L is a linker

“b” has a value of one or more;

“c” has a value in the range of from 0 to about 20; and

“n” has a value from 3 to 15. Such materials are useful as adhesives, and more specifically, medical adhesives that can be utilized as sealants.

The identifier “CA” refers to a central atom, a central point from which branching occurs, that can be carbon, oxygen, sulfur, a nitrogen atom or a secondary amine. It should be understood therefore, that when carbon is a central atom, that the central point is quaternary having a four armed branch. However, each of the four arms can be subsequently further branched. For example, the central carbon could be the pivotal point of a moiety such as 2,2-dimethylpentane, wherein each of the methylenes attached to the quaternary carbon could each form 3 branches for an ultimate total of 12 branches, to which then are attached one or more PA(s) defined herein below. An exemplary CA containing molecule is pentaerythritol, C(CH₂OH)₄.

Likewise, oxygen and sulfur can serve as the central atom. Both of these heteroatoms can then further be linked to, for example, a methylene or ethylene that is branched, forming multiple arms therefrom and to which are then attached one or more PA(s).

When the central atom is nitrogen, branching would occur so that at least 3 arms would form from the central nitrogen. However, each arm can be further branched depending on functionality linked to the nitrogen atom. As above, if the moiety is an ethylene, the ethylene group can serve as additional points of attachment (up to 5 points per ethylene) to which are then attached one or more PA(s). Hence, it is possible that a molecule where the central atom is nitrogen, could have up to 15 branches starting therefrom, wherein 3 fully substituted ethylene moieties are attached to the central nitrogen atom.

Where the central atom is a secondary amine,

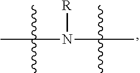

wherein R can be a hydrogen atom or an substituted or unsubstituted, branched or unbranched alkyl group. The remaining sites on the amine then would serve as points of attachment for at least 2 arms. Again, each arm can be further branched depending on functionality linked to the nitrogen atom. As above, if the moiety is an ethylene, the ethylene group can serve as additional points of attachment (up to 5 points per ethylene) to which are then attached one or more PA(s). Hence, it is possible that a molecule where the central atom is a secondary amine, there could be up to 10 branches emanating therefrom, wherein 2 fully substituted ethylene moieties are attached to the central nitrogen atom.

In particular, the central atom is a carbon atom that is attached to four PAs as defined herein.

It should be understood that the central atom (CA) can be part of a PA as further defined herein. In particular, the CA can be either a carbon or an oxygen atom when part of the PA.

The compound can include a spacer group, Z, that joins the central atom (CA) to the PA. Suitable spacer groups include C1 to C6 linear or branched, substituted or unsubstituted alkyl groups. In one embodiment, Z is a methylene (—CH₂—, ethylene —CH₂CH₂— or propene —CH₂CH₂CH₂—). Alternatively, the spacer group can be a bond formed between the central atom and a terminal portion of a PA.

“Alkyl,” by itself or as part of another substituent, refers to a saturated or unsaturated, branched, straight-chain or cyclic monovalent hydrocarbon radical derived by the removal of one hydrogen atom from a single carbon atom of a parent alkane, alkene or alkyne. Typical alkyl groups include, but are not limited to, methyl; ethyls such as ethanyl, ethenyl, ethynyl; propyls such as propan-1-yl, propan-2-yl, cyclopropan-1-yl, prop-1-en-1-yl, prop-1-en-2-yl, prop-2-en-1-yl (allyl), cycloprop-1-en-1-yl; cycloprop-2-en-1-yl, prop-1-yn-1-yl, prop-2-yn-1-yl, etc.; butyls such as butan-1-yl, butan-2-yl, 2-methyl-propan-1-yl, 2-methyl-propan-2-yl, cyclobutan-1-yl, but-1-en-1-yl, but-1-en-2-yl, 2-methyl-prop-1-en-1-yl, but-2-en-1-yl, but-2-en-2-yl, buta-1,3-dien-1-yl, buta-1,3-dien-2-yl, cyclobut-1-en-1-yl, cyclobut-1-en-3-yl, cyclobuta-1,3-dien-1-yl, but-1-yn-1-yl, but-1-yn-3-yl, but-3-yn-1-yl, etc.; and the like.

The term “alkyl” is specifically intended to include groups having any degree or level of saturation, i.e., groups having exclusively single carbon-carbon bonds, groups having one or more double carbon-carbon bonds, groups having one or more triple carbon-carbon bonds and groups having mixtures of single, double and triple carbon-carbon bonds. Where a specific level of saturation is intended, the expressions “alkanyl,” “alkenyl,” and “alkynyl” are used. Preferably, an alkyl group comprises from 1 to 15 carbon atoms (C₁-C₁₅ alkyl), more preferably from 1 to 10 carbon atoms (C₁-C₁₀ alkyl) and even more preferably from 1 to 6 carbon atoms (C₁-C₆ alkyl or lower alkyl).

“Alkanyl,” by itself or as part of another substituent, refers to a saturated branched, straight-chain or cyclic alkyl radical derived by the removal of one hydrogen atom from a single carbon atom of a parent alkane. Typical alkanyl groups include, but are not limited to, methanyl; ethanyl; propanyls such as propan-1-yl, propan-2-yl (isopropyl), cyclopropan-1-yl, etc.; butanyls such as butan-1-yl, butan-2-yl (sec-butyl), 2-methyl-propan-1-yl (isobutyl), 2-methyl-propan-2-yl (t-butyl), cyclobutan-1-yl, etc.; and the like.

“Alkenyl,” by itself or as part of another substituent, refers to an unsaturated branched, straight-chain or cyclic alkyl radical having at least one carbon-carbon double bond derived by the removal of one hydrogen atom from a single carbon atom of a parent alkene. The group may be in either the cis or trans conformation about the double bond(s). Typical alkenyl groups include, but are not limited to, ethenyl; propenyls such as prop-1-en-1-yl, prop-1-en-2-yl, prop-2-en-1-yl (allyl), prop-2-en-2-yl, cycloprop-1-en-1-yl; cycloprop-2-en-1-yl; butenyls such as but-1-en-1-yl, but-1-en-2-yl, 2-methyl-prop-1-en-1-yl, but-2-en-1-yl, but-2-en-1-yl, but-2-en-2-yl, buta-1,3-dien-1-yl, buta-1,3-dien-2-yl, cyclobut-1-en-1-yl, cyclobut-1-en-3-yl, cyclobuta-1,3-dien-1-yl, etc.; and the like.

“Alkyldiyl” by itself or as part of another substituent refers to a saturated or unsaturated, branched, straight-chain or cyclic divalent hydrocarbon group derived by the removal of one hydrogen atom from each of two different carbon atoms of a parent alkane, alkene or alkyne, or by the removal of two hydrogen atoms from a single carbon atom of a parent alkane, alkene or alkyne. The two monovalent radical centers or each valency of the divalent radical center can form bonds with the same or different atoms. Typical alkyldiyl groups include, but are not limited to, methandiyl; ethyldiyls such as ethan-1,1-diyl, ethan-1,2-diyl, ethen-1,1-diyl, ethen-1,2-diyl; propyldiyls such as propan-1,1-diyl, propan-1,2-diyl, propan-2,2-diyl, propan-1,3-diyl, cyclopropan-1,1-diyl, cyclopropan-1,2-diyl, prop-1-en-1,1-diyl, prop-1-en-1,2-diyl, prop-2-en-1,2-diyl, prop-1-en-1,3-diyl, cycloprop-1-en-1,2-diyl, cycloprop-2-en-1,2-diyl, cycloprop-2-en-1,1-diyl, prop-1-yn-1,3-diyl, etc.; butyldiyls such as, butan-1,1-diyl, butan-1,2-diyl, butan-1,3-diyl, butan-1,4-diyl, butan-2,2-diyl, 2-methyl-propan-1,1-diyl, 2-methyl-propan-1,2-diyl, cyclobutan-1,1-diyl; cyclobutan-1,2-diyl, cyclobutan-1,3-diyl, but-1-en-1,1-diyl, but-1-en-1,2-diyl, but-1-en-1,3-diyl, but-1-en-1,4-diyl, 2-methyl-prop-1-en-1,1-diyl, 2-methanylidene-propan-1,1-diyl, buta-1,3-dien-1,1-diyl, buta-1,3-dien-1,2-diyl, buta-1,3-dien-1,3-diyl, buta-1,3-dien-1,4-diyl, cyclobut-1-en-1,2-diyl, cyclobut-1-en-1,3-diyl, cyclobut-2-en-1,2-diyl, cyclobuta-1,3-dien-1,2-diyl, cyclobuta-1,3-dien-1,3-diyl, but-1-yn-1,3-diyl, but-1-yn-1,4-diyl, buta-1,3-diyn-1,4-diyl, etc.; and the like. Where specific levels of saturation are intended, the nomenclature alkanyldiyl, alkenyldiyl and/or alkynyldiyl is used. Where it is specifically intended that the two valencies are on the same carbon atom, the nomenclature “alkylidene” is used. In preferred embodiments, the alkyldiyl group comprises from 1 to 6 carbon atoms (C1-C6 alkyldiyl). Also preferred are saturated acyclic alkanyldiyl groups in which the radical centers are at the terminal carbons, e.g., methandiyl (methano); ethan-1,2-diyl (ethano); propan-1,3-diyl (propano); butan-1,4-diyl (butano); and the like (also referred to as alkylenos, defined infra).

“Alkyleno,” by itself or as part of another substituent, refers to a straight-chain saturated or unsaturated alkyldiyl group having two terminal monovalent radical centers derived by the removal of one hydrogen atom from each of the two terminal carbon atoms of straight-chain parent alkane, alkene or alkyne. The locant of a double bond or triple bond, if present, in a particular alkyleno is indicated in square brackets. Typical alkyleno groups include, but are not limited to, methano; ethylenos such as ethano, etheno, ethyno; propylenos such as propano, prop[1]eno, propa[1,2]dieno, prop[1]yno, etc.; butylenos such as butano, but[1]eno, but[2]eno, buta[1,3]dieno, but[1]yno, but[2]yno, buta[1,3]diyno, etc.; and the like. Where specific levels of saturation are intended, the nomenclature alkano, alkeno and/or alkyno is used. In preferred embodiments, the alkyleno group is (C1-C6) or (C1-C3) alkyleno. Also preferred are straight-chain saturated alkano groups, e.g., methano, ethano, propano, butano, and the like.

“Alkylene” by itself or as part of another substituent refers to a straight-chain saturated or unsaturated alkyldiyl group having two terminal monovalent radical centers derived by the removal of one hydrogen atom from each of the two terminal carbon atoms of straight-chain parent alkane, alkene or alkyne. The locant of a double bond or triple bond, if present, in a particular alkylene is indicated in square brackets. Typical alkylene groups include, but are not limited to, methylene (methano); ethylenes such as ethano, etheno, ethyno; propylenes such as propano, prop[1]eno, propa[1,2]dieno, prop[1]yno, etc.; butylenes such as butano, but[1]eno, but[2]eno, buta[1,3]dieno, but[1]yno, but[2]yno, buta[1,3]diyno, etc.; and the like. Where specific levels of saturation are intended, the nomenclature alkano, alkeno and/or alkyno is used. In preferred embodiments, the alkylene group is (C1-C6) or (C1-C3) alkylene. Also preferred are straight-chain saturated alkano groups, e.g., methano, ethano, propano, butano, and the like.

“Substituted,” when used to modify a specified group or radical, means that one or more hydrogen atoms of the specified group or radical are each, independently of one another, replaced with the same or different substituent(s). Substituent groups useful for substituting saturated carbon atoms in the specified group or radical include, but are not limited to —R^{a}, halo, —O⁻, ═O, —OR^{b}, —SR^{b}, —S⁻, ═S, —NR^{c}R^{c}, ═NR^{b}, ═N—OR^{b}, trihalomethyl, —CF₃, —CN, —OCN, —SCN, —NO, —NO₂, ═N₂, —N₃, —S(O)₂R^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{b}C(S)R^{b}, —NR^{b}C(O)O⁻, —NR^{b}C(O)OR^{b}, —NR^{b}C(S)OR^{b}, —NR^{b}C(O)R^{c}R^{c}, —NR^{b}C(NR^{b})R^{b} and —NR^{b}C(NR^{b})NR^{c}R^{c}, where R^{a} is selected from the group consisting of alkyl, cycloalkyl, heteroalkyl, cycloheteroalkyl, aryl, arylalkyl, heteroaryl and heteroarylalkyl; each R^{b} is independently hydrogen or R^{a}; and each R^{c} is independently R^{b} or alternatively, the two R^{c}s are taken together with the nitrogen atom to which they are bonded form a 5-, 6- or 7-membered cycloheteroalkyl which may optionally include from 1 to 4 of the same or different additional heteroatoms selected from the group consisting of O, N and S. As specific examples, —NR^{c}R^{c} is meant to include —NH₂, —NH-alkyl, N-pyrrolidinyl and N-morpholinyl.

Similarly, substituent groups useful for substituting unsaturated carbon atoms in the specified group or radical include, but are not limited to, —R^{a}, halo, —O⁻, —OR^{b}, —SR^{b}, —S⁻, —NR^{c}R^{c}, trihalomethyl, —CF₃, —CN, —OCN, —SCN, —NO, —NO₂, —N₃, —S(O)₂R^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)O⁻, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)O⁻, —OC(O)OR^{b}, —OC(S)OR^{b}, —NR^{b}C(O)R^{b}, —NR^{b}C(S)R^{b}, —NR^{b}C(O)O⁻, —NR^{b}C(O)OR^{b}, —NR^{b}C(S)OR^{b}, —NR^{b}C(O)R^{c}R^{c}, —NR^{b}C(NR^{b})R^{b} and —NR^{b}C(NR^{b})NR^{c}R^{c}, where R^{a}, R^{b} and R^{c} are as previously defined.

Substituent groups useful for substituting nitrogen atoms in heteroalkyl and cycloheteroalkyl groups include, but are not limited to, —R^{a}, —O⁻, —OR^{b}, —SR^{b}, —S⁻, —NR^{c}R^{c}, trihalomethyl, —CF₃, —CN, —NO, —NO₂, —S(O)₂R^{b}, —S(O)₂O⁻, —S(O)₂OR^{b}, —OS(O)₂R^{b}, —OS(O)₂O⁻, —OS(O)₂OR^{b}, —P(O)(O⁻)₂, —P(O)(OR^{b})(O⁻), —P(O)(OR^{b})(OR^{b}), —C(O)R^{b}, —C(S)R^{b}, —C(NR^{b})R^{b}, —C(O)OR^{b}, —C(S)OR^{b}, —C(O)NR^{c}R^{c}, —C(NR^{b})NR^{c}R^{c}, —OC(O)R^{b}, —OC(S)R^{b}, —OC(O)OR^{b}, —OC(S)OR^{b}, —NR^{b}C(O)R^{b}, —NR^{b}C(S)R^{b}, —NR^{b}C(O)OR^{b}, —NR^{b}C(S)OR^{b}, —NR^{b}C(O)R^{c}R^{c}—NR^{b}C(NR^{b})R^{b} and —NR^{b}C(NR^{b})NR^{c}R^{c}, where R^{a}, R^{b} and R^{c} are as previously defined.

Substituent groups from the above lists useful for substituting other specified groups or atoms will be apparent to those of skill in the art.

The substituents used to substitute a specified group can be further substituted, typically with one or more of the same or different groups selected from the various groups specified above.

The identifier “PA” refers to a poly(alkylene oxide) or substantially poly(alkylene oxide) and means predominantly or mostly alkyloxide or alkyl ether in composition. This definition contemplates the presence of heteroatoms e.g., N, O, S, P, etc. and of functional groups e.g., —COOH, —NH₂, —SH, as well as ethylenic or vinylic unsaturation. It is to be understood any such non-alkyleneoxide structures will only be present in such relative abundance as not to materially reduce, for example, the overall surfactant, non-toxicity, or immune response characteristics, as appropriate, or of this polymer. It should also be understood that PAs can include terminal end groups such as PA-O—CH₂—CH₂—NH₂, e.g., PEG-O—CH₂—CH₂—NH₂ (as a common form of amine terminated PA). PA-O—CH₂—CH₂—CH₂—NH₂, e.g., PEG-O—CH₂—CH₂—CH₂—NH₂ is also available as well as PA-O—(CH₂—CH(CH₃)—O)ₓₓ—CH₂—CH(CH₃)—NH₂, where xx is 0 to about 3, e.g., PEG-O—(CH₂—CH(CH₃)—O)ₓₓ—CH₂—CH(CH₃)—NH₂ and a PA with an acid end-group typically has a structure of PA-O—CH₂—COOH, e.g., PEG-O—CH₂—COOH. These are all contemplated as being within the scope of the invention and should not be considered limiting.

Generally each PA of the molecule has a molecular weight between about 1,250 and about 12,500 daltons and most particularly between about 2,500 and about 5,000 daltons. Therefore, it should be understood that the desired MW of the whole or combined polymer is between about 5,000 and about 50,000 Da with the most preferred MW of between about 10,000 and about 20,000 Da, where the molecule has four “arms”, each arm having a MW of between about 1,250 and about 12,500 daltons with the most preferred MW of 2,500 and about 5,000 Da.

Suitable PAs (polyalkylene oxides) include polyethylene oxides (PEOs), polypropylene oxides (PPOs), polyethylene glycols (PEGs) and combinations thereof that are commercially available from SunBio Corporation, JenKem Technology USA, NOF America Corporation. In one embodiment, the PA is a polyalkylene glycol polyether or derivative thereof, and most particularly is polyethylene glycol (PEG), the PEG unit having a molecular weight generally in the range of between about 1,250 and about 12,500 daltons, in particular between about 2,500 and about 5,000 daltons.

It should be understood that, for example, polyethylene oxide can be produced by ring opening polymerization of ethylene oxide as is known in the art.

In one embodiment, the PA can be a block copolymer of a PEO and PPO or a PEG or a triblock copolymer of PEO/PPO/PEO.

It should be understood that the PA terminal end groups can be functionalized. Typically the end groups are OH, NH₂, COOH, or SH. However, these groups can be converted into a halide (Cl, Br, I), an activated leaving group, such as a tosylate or mesylate, an ester, an acyl halide, N-succinimidyl carbonate, 4-nitrophenyl carbonate, and chloroformate with the leaving group being N-hydroxy succinimide, 4-nitrophenol, and Cl, respectively. etc.

The notation of “L” refers to either a linker or a linking group. A “linker” refers to a moiety that has two points of attachment on either end of the moiety. For example, an alkyl dicarboxylic acid HOOC-alkyl-COOH (e.g., succinic acid) would “link” a terminal end group of a PA (such as a hydroxyl or an amine to form an ester or an amide respectively) with a reactive group of the DHPD (such as an NH₂, OH, or COOH). Suitable linkers include an acyclic hydrocarbon bridge (e.g, a saturated or unsaturated alkyleno such as methano, ethano, etheno, propano, prop[1]eno, butano, but[1]eno, but[2]eno, buta[1,3]dieno, and the like), a monocyclic or polycyclic hydrocarbon bridge (e.g., [1,2]benzeno, [2,3]naphthaleno, and the like), a monocyclic or polycyclic heteroaryl bridge (e.g., [3,4]furano[2,3]furano, pyridino, thiopheno, piperidino, piperazino, pyrazidino, pyrrolidino, and the like) or combinations of such bridges, dicarbonyl alkylenes, etc. Suitable dicarbonyl alkylenes include, C3 through C10 dicarbonyl alkylenes such as malonic acid, succinic acid, etc.

A linking group refers to the reaction product of the terminal end moieties of the PA and DHPD (the situation where “a” is 0; no linker present) condense to form an amide, ester, urea, carbonate or urethane linkage depending on the reactive sites on the PA and DHPD. In other words, a direct bond is formed between the PA and DHPD portion of the molecule and no linker is present.

The denotation “DHDP” refers to a multihydroxy phenyl derivative, such as a dihydroxy phenyl derivative, for example, a 3,4 dihydroxy phenyl moiety. Suitable DHDP derivatives include the formula:

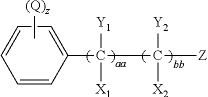

wherein Q is an OH;

“z” is 2 to 5;

each X₁, independently, is H, NH₂, OH, or COOH;

each Y₁, independently, is H, NH₂, OH, or COOH;

each X₂, independently, is H, NH₂, OH, or COOH;

each Y₂, independently, is H, NH₂, OH, or COOH;

Z is COOH, NH₂, OH or SH;

aa is a value of 0 to about 4;

bb is a value of 0 to about 4; and

optionally provided that when one of the combinations of X₁ and X₂, Y₁ and Y₂, X₁ and Y₂ or Y₁ and X₂ are absent, then a double bond is formed between the Cₐₐ and C_{bb}, further provided that aa and bb are each at least 1 when a double bond is present.

In one aspect, z is 3.

In particular, “z” is 2 and the hydroxyls are located at the 3 and 4 positions of the phenyl ring.

In one embodiment, each X₁, X₂, Y₁ and Y₂ are hydrogen atoms, aa is 1, bb is 1 and Z is either COOH or NH₂.

In another embodiment, X₁ and Y₂ are both hydrogen atoms, X₂ is a hydrogen atom, aa is 1, bb is 1, Y₂ is NH₂ and Z is COOH.

In still another embodiment, X₁ and Y₂ are both hydrogen atoms, aa is 1, bb is 0, and Z is COOH or NH₂.

In still another embodiment, aa is 0, bb is 0 and Z is COOH or NH₂.

In still yet another embodiment, z is 3, aa is 0, bb is 0 and Z is COOH or NH₂.

It should be understood that where aa is 0 or bb is 0, then X₁ and Y₁ or X₂ and Y₂, respectively, are not present.

It should be understood, that upon condensation of the DHDP molecule with the PA that a molecule of water, for example, is generated such that a bond is formed as described above (amide, ester, urea, carbonate or urethane).

In particular, DHPD molecules include dopamine, 3,4-dihydroxy phenylalanine (DOPA), dihydroxyhydrocinnamic acid, 3,4-dihydroxyphenyl ethanol, 3,4 dihydroxyphenylacetic acid, 3,4 dihydroxyphenylamine, etc.

The denotation “AA” refers to an optional amino acid moiety or segment comprising one or more amino acids. Of particular interest are those amino acids with polar side chains, and more particularly amino acids with polar side chains and which are weakly to strongly basic. Amino acids with polar acidic, polar-neutral, non-polar neutral side chains are within the contemplation of the present invention. For some applications non-polar side chain amino acids may be more important for maintenance and determination three-dimensional structure than, e.g., enhancement of adhesion. Suitable amino acids are lysine, arginine and histidine, with any of the standard amino acids potentially being useable. Non-standard amino acids are also contemplated by the present invention.

The denotation “PG” refers to an optional protecting group, and if absent, is a hydrogen atom. A “protecting group” refers to a group of atoms that, when attached to a reactive functional group in a molecule, mask, reduce or prevent the reactivity of the functional group. Typically, a protecting group may be selectively removed as desired during the course of a synthesis. Examples of protecting groups can be found in Greene and Wuts, Protective Groups in Organic Chemistry, 3^{rd} Ed., 1999, John Wiley & Sons, NY and Harrison et al., Compendium of Synthetic Organic Methods, Vols. 1-8, 1971-1996, John Wiley & Sons, NY. Representative amino protecting groups include, but are not limited to, formyl, acetyl, trifluoroacetyl, benzyl, benzyloxycarbonyl (“CBZ”), tert-butoxycarbonyl (“Boc”), trimethylsilyl (“TMS”), 2-trimethylsilyl-ethanesulfonyl (“SES”), trityl and substituted trityl groups, allyloxycarbonyl, 9-fluorenylmethyloxycarbonyl (“FMOC”), nitro-veratryloxycarbonyl (“NVOC”) and the like. Representative hydroxyl protecting groups include, but are not limited to, those where the hydroxyl group is either acylated (e.g., methyl and ethyl esters, acetate or propionate groups or glycol esters) or alkylated such as benzyl and trityl ethers, as well as alkyl ethers, tetrahydropyranyl ethers, trialkylsilyl ethers (e.g., TMS or TIPPS groups) and allyl ethers.

The denotation “a” refers to a value of 0 when no linker is present (a bond is formed between the terminal end reactive portions of a PA and a DHPD) or is 1 when a linker is present.

The denotation of “b” has a value of one or more, typically between about 1 and about 20, more particularly between about 1 and about 10 and most particularly between about 1 and about 5, e.g., 1 to 3 inclusive. It should be understood that the DHPD can be one or more DHPD different molecules when b is 2 or more

The denotation of “c” refers to a value of from 0 to about 20. It should be understood that the AA can be one or more different amino acids if c is 2 or more. In one embodiment, the sum of b+c is between 1 to about 20, in particular between about 1 to about 10 and more particularly between about 1 and about 5.

The denotation of “n” refers to values from 3 to about 15. In particular, n is 3, 4, or 5.

Note that as indicated in formula I, DHPD and AA moieties can be segments or “blocks” and can be and often are interspersed such that the DHPD/AA portion of each “arm” molecule can be a random copolymer or a random “block” copolymer. Therefore, for example, formula I(a) comprises:

While generally conforming to structural formula I, the “arms” of the compositions of this invention are separately and independently the same or different.

The present invention provides in one embodiment, a multi-armed, poly (alkylene oxide) polyether, multihydroxy (dihydroxy)phenyl derivative (DHPD) having the general formula:

CA-[Z-PA-(L)ₐ-(DHPD)_{b}-(AA)_{c}-PG]ₙ

wherein

CA is a central atom that is carbon;

each Z, independently, is a C1 to a C6 linear or branched, substituted or unsubstituted alkyl group or a bond;

each PA, individually, is a substantially poly(alkylene oxide) polyether or derivative thereof;

each L, independently, optionally, is a linker or is a linking group selected from amide, ester, urea, carbonate or urethane linking groups;

each DHPD, independently, is a multihydroxy phenyl derivative;

each AA, independently, optionally, is an amino acid moiety,

each PG, independently, is an optional protecting group, and if the protecting group is absent, each PG is replaced by a hydrogen atom;

“a” has a value of 0 when L is a linking group or a value of 1 when L is a linker;

“b” has a value of one or more;

“c” has a value in the range of from 0 to about 20; and

“n” has a value of 4. Such materials are useful as adhesives, and more specifically, medical adhesives that can be utilized as sealants.

In one aspect, CA is a carbon atom and each Z is a methylene.

In another aspect, CA is a carbon atom, each Z is a methylene and each PA is a polyethylene oxide polyether that is a polyethylene oxide (PEG). The molecular weight of each PEG unit is between about 1,250 and about 12,500 daltons, in particular between about 2,500 and about 5,000 daltons.

In still another aspect, CA is a carbon atom, each Z is a methylene, each PA is a polyethylene oxide polyether that is a polyethylene oxide (PEG) and the linking group is an amide, ester, urea, carbonate or urethane. The molecular weight of each PEG unit is between about 1,250 and about 12,500 daltons, in particular between about 2,500 and about 5,000 daltons. In particular, the linking group is an amide, urethane or ester.

In still another aspect, CA is a carbon atom, each Z is a methylene, each PA is a polyethylene oxide polyether that is a polyethylene oxide (PEG), the linking group is an amide, ester, urea, carbonate or urethane and the DHDP is dopamine, 3,4-dihydroxyphenyl alanine, 3,4-dihydroxyphenyl ethanol or 3,4-dihydroxyhydrocinnamic acid (or combinations thereof). The molecular weight of each PEG unit is between about 1,250 and about 12,500 daltons, in particular between about 2,500 and about 5,000 daltons. In particular, the linking group is an amide, urethane or ester.

In still another aspect, CA is a carbon atom, each Z is a methylene, each PA is a polyethylene oxide polyether that is a polyethylene oxide (PEG), the linking group is an amide, ester, urea, carbonate or urethane, the DHDP is dopamine, 3,4-dihydroxyphenyl alanine, 3,4-dihydroxyphenyl ethanol or 3,4-dihydroxyhydrocinnamic acid (or combinations thereof) and each AA is lysine. The molecular weight of each PEG unit is between about 1,250 and about 12,500 daltons, in particular between about 2,500 and about 5,000 daltons. In particular, the linking group is an amide, urethane or ester.

In still another aspect, CA is a carbon atom, each Z is a methylene, each PA is a polyethylene oxide polyether that is a polyethylene oxide (PEG), the linking group is an amide, ester, urea, carbonate or urethane, the DHDP is dopamine, 3,4-dihydroxyphenyl alanine, 3,4-dihydroxyphenyl ethanol or 3,4-dihydroxyhydrocinnamic acid (or combinations thereof) and the PG is either a “Boc” or a hydrogen atom. The molecular weight of each PEG unit is between about 1,250 and about 12,500 daltons, in particular between about 2,500 and about 5,000 daltons. In particular, the linking group is an amide, urethane or ester.

In certain embodiments, “b” has a value of 1, 2, 3, or 4.

In certain embodiments, “c” has a value of zero, 1, 2, 3 or 4.

AA moieties can be segments or “blocks” and can be and often are interspersed such that the DHPD/AA portion of each “arm” molecule can be a random copolymer or a random or sequenced “block” copolymer. Therefore, for example, comprising the general formula:

CA-[Z-PA-(L)ₐ-[(DHPD)_{b}-(AA)_{c}]_{zz}-PG]ₙ

wherein CA is a carbon atom, Z, PA, L, DHPD, AA, PG, “a”, “b”, “c” and “n” are as defined above and zz is from 1 to about 20, in particular from about 2 to about 10 and most particularly from about 4 to about 8.

In certain embodiment, molecules according to this invention may be represented by:

C[—(OCH₂—CH₂)ₙ₁-[(DOPA)ₙ₂-(lys)ₙ₃]ₐ[(lys)ₙ₃-(DOPA)ₙ₂]_{b}]₄

wherein a+b=1 meaning if a is 1 b is 0 and vice versa;

n₁ has a value in the range of about 10 to 500, preferably about 20 to about 250, and most preferably about 25 to about 100, for example, n₁ has value of between about 28 and 284 for PA of between about 1,250 and about 12,500 Da and in particular between about 56 and about 113 for a PA of between about 2,500 and about 5,000 Da;

n₂ has a value of 1 to about 10; n₃ has a value of 0 to about 10. In the above formula, it is to be understood that DOPA-lys (or other amino acids) peptide can be sequential or random.

Typically, formulations of the invention (the adhesive composition) have a solids content of between about 10% to about 50% solids by weight, in particular between about 15% and about 40% by weight and particularly between about 20% and about 35% by weight.

Exemplifying this invention, refined liquid adhesives possessing related chemical architecture were synthesized. For example, branched, 4-armed poly(ethylene glycol) (PEG) end-functionalized with a single DOPA (C-(PEG-DOPA-Boc)₄), several DOPA residues (C-(PEG-DOPA₄)₄), a randomly alternating DOPA-lysine peptide (C-(PEG-DOPA₃-Lys₂)₄), a deaminated DOPA, 3,4-dihydroxyhydrocinnamic acid (C-(PEG-DOHA)₄), a dopamine through a urethane-linkage (C-(PEG-DMu)₄) and dopamine succinamic acid through an ester-linkage (C-(PEG-DMe)₄) are representative.

C-(PEG)-(DOHA)₄ is also sometimes referred to as Quadra Seal-DH herein. Regardless of polymer formulation, DOPA provides both adhesive and cohesive properties to the system, as it does in the naturally occurring MAPs. Without wishing to be bound to a theory, it is believed that the addition of the preferred amino acid lysine, contributes to adhesive interactions on metal oxide surfaces through electrostatic interactions with negatively charged oxides. Cohesion or crosslinking is achieved via oxidation of DOPA catechol by sodium periodate (NaIO₄) to form reactive quinone. It is further theorized, again without wishing to be bound by a theory, that quinone can react with other nearby catechols and functional groups on surfaces, thereby achieving covalent crosslinking

The phrase “pharmaceutically acceptable carrier” means a pharmaceutically-acceptable material, composition or vehicle, such as a liquid or solid filler, diluent, excipient, solvent or encapsulating material that can be combined with the adhesive compositions of the invention. Each carrier should be “acceptable” in the sense of being compatible with the other ingredients of the composition and not injurious to the individual. Some examples of materials which may serve as pharmaceutically-acceptable carriers include: sugars, such as lactose, glucose and sucrose; starches, such as corn starch and potato starch; cellulose, and its derivatives, such as sodium carboxymethyl cellulose, ethyl cellulose and cellulose acetate; powdered tragacanth; malt; gelatin; talc; excipients, such as cocoa butter and suppository waxes; oils, such as peanut oil, cottonseed oil, safflower oil, sesame oil, olive oil, corn oil and soybean oil; glycols, such as propylene glycol; polyols, such as glycerin, sorbitol, mannitol and polyethylene glycol; esters, such as ethyl oleate and ethyl laurate; agar; buffering agents, such as magnesium hydroxide and aluminum hydroxide; alginic acid; pyrogen-free water; isotonic saline; Ringer's solution; ethyl alcohol; phosphate buffer solutions; phosphate buffered saline with a neutral pH and other non-toxic compatible substances employed in pharmaceutical formulations.

In still another aspect, blends of the compounds of the invention described herein, can be prepared with various polymers. Polymers suitable for blending with the compounds of the invention are selected to impart non-covalent interactions with the compound(s), such as hydrophobic-hydrophobic interactions or hydrogen bonding with an oxygen atom on PEG and a substrate surface. These interactions can increase the cohesive properties of the film to a substrate. If a biopolymer is used, it can introduce specific bioactivity to the film, (i.e. biocompatibility, cell binding, immunogenicity, etc.).

Suitable polymers include, for example, polyesters, PPG, linear PCL-diols (MW 600-2000), branched PCL-triols (MW 900), wherein PCL can be replaced with PLA, PGA, PLGA, and other polyesters, amphiphilic block (di, tri, or multiblock) copolymers of PEG and polyester or PPG, tri-block copolymers of PCL-PEG-PCL (PCL MW=500-3000, PEG MW=500-3000), tri-block copolymers of PLA-PEG-PLA (PCL MW=500-3000, PEG MW=500-3000), wherein PCL and PLA can be replaced with PGA, PLGA, and other polyesters. Pluronic polymers (triblock, diblock of various MW) and other PEG, PPG block copolymers are also suitable. Hydrophilic polymers with multiple functional groups (—OH, —NH₂, —COOH) contained within the polymeric backbone such as PVA (MW 10,000-100,000), poly acrylates and poly methacrylates, polyvinylpyrrolidone, and polyethylene imines are also suitable. Biopolymers such as polysaccharides (e.g., dextran), hyaluronic acid, chitosan, gelatin, cellulose (e.g., carboxymethyl cellulose), proteins, etc. which contain functional groups can also be utilized.

Abbreviations: PCL=polycaprolactone, PLA=polylactic acid, PGA=Polyglycolic acid, PLGA=a random copolymer of lactic and glycolic acid, PPG=polypropyl glycol, and PVA=polyvinyl alcohol.

Typically, blends of the invention include from about 0 to about 99.9% percent (by weight) of polymer to composition(s) of the invention, more particularly from about 1 to about 50 and even more particularly from about 1 to about 30.

The compositions of the invention, either a blend or a compound of the invention per se, can be applied to suitable substrates using conventional techniques. Coating, dipping, spraying, spreading and solvent casting are possible approaches.

The present invention surprisingly provides unique antifouling coatings/constructs that are suitable for application in, for example, urinary applications. The coatings could be used anywhere that a reduction in bacterial attachment is desired: dental unit waterlines, implantable orthopedic devices, cardiovascular devices, wound dressings, percutaneous devices, surgical instruments, marine applications, food preparation surfaces and utensils.

The present invention surprisingly provides unique bioadhesive constructs that are suitable to repair or reinforce damaged tissue.

Suitable supports include those that can be formed from natural materials, such as collagen, metal surfaces such as titanium, iron, steel, etc. or man made materials such as polypropylene, polyethylene, polybutylene, polyesters, PTFE, PVC, polyurethanes and the like. The support can be a solid surface such as a film, sheet, coupon or tube, a membrane, a mesh, a non-woven and the like. The support need only help provide a surface for the coating to adhere.

Other suitable supports can be formed from a natural material, such as collagen, pericardium, dermal tissues, small intestinal submucosa and the like. The support can be a film, a membrane, a mesh, a non-woven and the like. The support need only help provide a surface for the bioadhesive/coating to adhere. The support should also help facilitate physiological reformation of the tissue at the damaged site. Thus the constructs of the invention provide a site for remodeling via fibroblast migration, followed by subsequent native collagen deposition. For biodegradable support of either biological or synthetic origins, degradation of the support and the adhesive can result in the replacement of the bioadhesive construct by the natural tissues of the patient.

The coatings of the invention can include a compound of the invention or mixtures thereof or a blend of a polymer with one or more of the compounds of the invention. In one embodiment, the construct is a combination of a substrate, to which a blend is applied, followed by a layer(s) of one or more compounds of the invention.

In another embodiment, two or more layers can be applied to a substrate wherein the layering can be combinations of one or more blends or one or more compositions of the invention. The layering can alternate between a blend and a composition layer or can be a series of blends followed by a composition layer or vice versa.

It has interestingly been found that use of a blend advantageously has improved adhesion to the substrate surface. For example, a blend of a hydrophobic polymer with a composition of the invention should have improved adhesion to a hydrophobic substrate. Subsequent application of a composition as described herein to the blend layer then provides improved interfacial adhesion between the blend and provides for improved adhesive properties to the tissue to be adhered to as the hydrophobic polymer is not in the outermost layer.

Typically the loading density of the coating layer is from about 0.001 g/m² to about 200 g/m², more particularly from about 5 g/m² to about 150 g/m², and more particularly from about 10 g/m² to about 100 g/m². Thus, typically a coating has a thickness of from about 1 to about 200 nm. More typically for an adhesive, the thickness of the film is from about 1 to about 200 microns.

Additional terms/abbreviations useful throughout the application include:

Medhesive-022=PEU-1

Medhesive-023=PEU-2

Medhesive-024=PEEU-1

Medhesive-026=PEU-3

Medhesive-027=PEEU-3

Medhesive-038=Medhesive-022, wherein a 2k PEG is used wherein a 1k PEG is used in Medhesive-022

Nerites-1=QuadraSeal-DH

Nerites-2=Mehesive-023

Nerites-3=Mehesive-038

Nerites-4=Mehesive-026

Nerites-5=Mehesive-024

Nerites-6=Mehesive-027

Nerites-7=Mehesive-030

Nerites-8=Mehesive-043

The following paragraphs enumerated consecutively from 1 through 30 provide for various aspects of the present invention. In one embodiment, in a first paragraph (1), the present invention provides a lend of a polymer and a multihydroxyphenyl (DHPD) functionalized polymer (DHPp), wherein the DHPp comprises the formula:

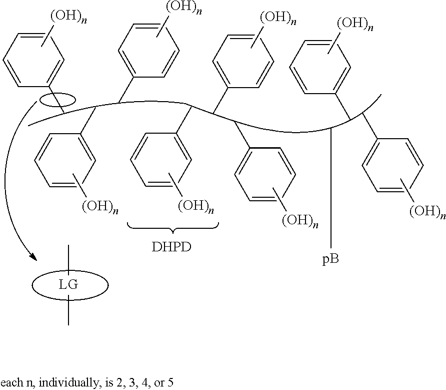

wherein LG is an optional linking group or linker, DHPD is a multihydroxyphenyl group, each n, individually, is 2, 3, 4 or 5, and pB is a polymeric backbone.

2. The blend of paragraph 1, further comprising an oxidant.

3. The blend of either of paragraphs 1 or 2, wherein the oxidant is formulated with the coating.

4. The blend of either of paragraphs 1 or 2, wherein the oxidant is applied to the coating.

5. The blend of any of paragraphs 1 through 3, further comprising a support, wherein the support is a film, a mesh, a membrane, a nonwoven or a prosthetic.

6. The blend of paragraph 4, further comprising a support, wherein the support is a film, a mesh, a membrane, a nonwoven or a prosthetic.

7. The blend of any of paragraphs 1 through 3 or 5, wherein the construct is hydrated.

8. The blend of either of paragraphs 4 or 6, wherein the construct is hydrated.

9. The blend of any of paragraphs 1 through 8, wherein the DHPD comprises at least about 1 to 100 weight percent of the DHPp.

10. The blend of any of paragraphs 1 through 8, wherein the DHPD comprises at least about 2 to about 65 weight percent of the DHPp.

11. The blend of any of paragraphs 1 through 8, wherein the DHPD comprises at least about 3 to about 55 weight percent of the DHPp.

12. The blend of any of paragraphs 1 through 8, wherein the pB consists essentially of a polyalkylene oxide.

13. The blend of any of paragraphs 1 through 8, wherein the pB is substantially a homopolymer.

14. The blend of any of paragraphs 1 through 8, wherein the pB is substantially a copolymer.

15. The blend of any of paragraphs 1 through 14, wherein the DHPD is a 3,4 dihydroxy phenyl.

16. The blend of any of paragraphs 1 through 15, wherein the DHPD's are linked to the pB via a urethane, urea, amide, ester, carbonate or carbon-carbon bond.

17. The blend of any of paragraphs 1 through 16, wherein the DHPp polymer comprises the formula:

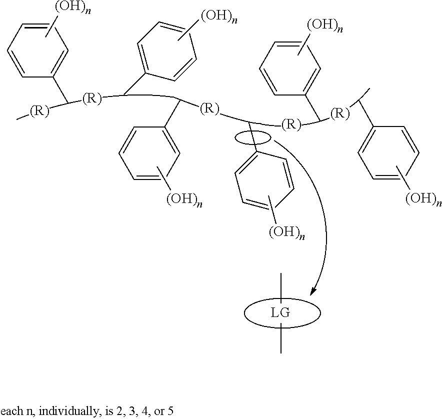

wherein R is a monomer or prepolymer linked or polymerized to form pB, pB is a polymeric backbone, LG is an optional linking group or linker and each n, individually, is 2, 3, 4 or 5.

18. The blend of paragraph 17, wherein R is a polyether, a polyester, a polyamide, a polyacrylate a polymethacrylate or a polyalkyl.

19. The blend of either of paragraphs 17 or 18, wherein the DHPD is a 3,4 dihydroxy phenyl.

20. The blend of any of paragraphs 17 through 19, wherein the DHPD's are linked to the pB via a urethane, urea, amide, ester, carbonate or carbon-carbon bond.

21. The blend of any of paragraphs 1 through 8, wherein the DHPp polymer comprises the formula:

CA-[Z-PA-(L)ₐ-(DHPD)_{b}-(AA)_{c}-PG]ₙ

wherein

CA is a central atom that is carbon;

each Z, independently, is a C1 to a C6 linear or branched, substituted or unsubstituted alkyl group or a bond;

each PA, independently, is a substantially poly(alkylene oxide) polyether or derivative thereof;

each L, independently, optionally, is a linker or is a linking group selected from amide, ester, urea, carbonate or urethane linking groups;

each DHPD, independently is a multihydroxy phenyl derivative;

each AA independently, optionally, is an amino acid moiety,

each PG, independently, is an optional protecting group, and if the protecting group is absent, each PG is replaced by a hydrogen atom;

“a” has a value of 0 when L is a linking group or a value of 1 when L is a linker;

“b” has a value of one or more;

“c” has a value in the range of from 0 to about 20; and

“n” has a value of 4.

22. The blend of paragraph 21, wherein each DHPD is either dopamine, 3,4-dihydroxyphenyl alanine, 2-(3,4-dihydroxyphenyl)ethanol, or 3,4-dihydroxyhydrocinnamic acid.

23. The blend of either of paragraphs 21 or 22, wherein the linking group is an amide, urea or urethane.

24. The blend of any of paragraphs 1 through 8, wherein the DHPp polymer comprises the formula:

CA-[Z-PA-(L)ₐ-(DHPD)_{b}-(AA)_{c}-PG]ₙ

wherein

CA is a central atom selected from carbon, oxygen, sulfur, nitrogen, or a secondary amine;

each Z, independently is a C1 to a C6 linear or branched, substituted or unsubstituted alkyl group or a bond;

each PA, independently, is a substantially poly(alkylene oxide) polyether or derivative thereof;

each L, independently, optionally, is a linker or is a linking group selected from amide, ester, urea, carbonate or urethane linking groups;

each DHPD, independently, is a multihydroxy phenyl derivative;

each AA, independently, optionally, is an amino acid moiety,

each PG, independently, is an optional protecting group, and if the protecting group is absent, each PG is replaced by a hydrogen atom;

“a” has a value of 0 when L is a linking group or a value of 1 when L is a linker;

“b” has a value of one or more;

“c” has a value in the range of from 0 to about 20; and

“n” has a value from 3 to 15.

25. The blend of any of paragraphs 1 through 24, wherein the polymer is present in a range of about 1 to about 50 percent by weight.

26. The blend of any of paragraphs 1 through 24, wherein the polymer is present in a range of about 1 to about 30 percent by weight.

27. A bioadhesive construct comprising:

a support;

a first coating comprising a blend of any of paragraphs 1 through 26 and

a second coating coated onto the first coating, wherein the second coating comprises a multihydroxyphenyl (DHPD) functionalized polymer (DHPp) of any of paragraphs 1 through 26.

28. A bioadhesive construct comprising:

a support;

a first coating comprising a blend of any of paragraphs 1 through 26; and

a second coating coated onto the first coating, wherein the second coating comprises a second blend, wherein the first and second blend may be the same or different.

29. A bioadhesive construct comprising:

a support;

a first coating comprising a first multihydroxyphenyl (DHPD) functionalized polymer (DHPp) of any of paragraphs 1 through 26; and

a second coating coated onto the first coating, wherein the second coating comprises a second multihydroxyphenyl (DHPD) functionalized polymer (DHPp) of any of paragraphs 1 through 26, wherein the first and second DHPp can be the same or different.

30. A method to reduce bacterial growth on a substrate surface, comprising the step of coating a multihydroxyphenyl (DHPD) functionalized polymer (DHPp) of any of paragraphs 1 through 26 or blends thereof onto the surface of the substrate.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

Examples from Ser. No. 11/834,651

### Example 1

### Synthesis of DMA1

20 g of sodium borate, 8 g of NaHCO₃ and 10 g of dopamine HCl (52.8 mmol) were dissolved in 200 mL of H₂O and bubbled with Ar. 9.4 mL of methacrylate anhydride (58.1 mmol) in 50 mL of THF was added slowly. The reaction was carried out overnight and the reaction mixture was washed twice with ethyl acetate and the organic layers were discarded. The aqueous layer was reduced to a pH<2 and the crude product was extracted with ethyl acetate. After reduction of ethyl acetate and recrystallization in hexane, 9 g of DMA1 (41 mmol) was obtained with a 78% yield. Both ¹H and ¹³C NMR was used to verify the purity of the final product.

### Example 2

### Synthesis of DMA2

20 g of sodium borate, 8 g of NaHCO₃ and 10 g of dopamine HCl (52.8 mmol) were dissolved in 200 mL of H₂O and bubbled with Ar. 8.6 mL acryloyl chloride (105 mmol) in 50 mL THF was then added dropwise. The reaction was carried out overnight and the reaction mixture was washed twice with ethyl acetate and the organic layers were discarded. The aqueous layer was reduced to a pH<2 and the crude product was extracted with ethyl acetate. After reduction of ethyl acetate and recrystallization in hexane, 6.6 g of DMA2 (32 mmol) was obtained with a 60% yield. Both ¹H and ¹³C NMR was used to verify the purity of the final product.

### Example 3

### Synthesis of DMA3

30 g of 4,7,10-trioxa-1,13-tridecanediamine (3EG-diamine, 136 mmol) was added to 50 mL of THF. 6.0 g of di-tert-butyl dicarbonate (27.2 mmol) in 30 mL of THF was added slowly and the mixture was stirred overnight at room temperature. 50 mL of deionized water was added and the solution was extracted with 50 mL of DCM four times. The combined organic layer was washed with saturated NaCl and dried over MgSO₄. After filtering MgSO₄ and removing DCM through reduced pressure, 8.0 g of Boc-3EG-NH₂ was obtained. Without further purification, 8.0 g of Boc-3EG-NH₂ (25 mmol) and 14 mL of triethyl amine (Et₃N, 100 mmol) were add to 50 mL of DCM and placed in an ice water bath. 16 mL of methacrylic anhydride (100 mmol) in 35 mL of DCM was added slowly and the mixture was stirred overnight at room temperature. After washing with 5% NaHCO₃, 1N HCl, and saturated NaCl and drying over MgSO₄, the DCM layer was reduced to around 50 mL. 20 mL of 4N HCl in dioxane was added and the mixture was stirred at room temperature for 30 min. After removing the solvent mixture and drying the crude product in a vacuum, the crude product was further purified by precipitation in an ethanol/hexane mixture to yield 9.0 g of MA-3EG-NH₂HCl. 9.0 g of MA-3EG-NH₂HCl was dissolved in 100 mL of DCM and 6.1 g of 3,4-dihydroxyhydrocinnamic acid (DOHA, 33.3 mmol) in 50 mL of DMF, 4.46 g of 1-hydroxybenzotriazole hydrate (HOBt, 33.3 mmol), 12.5 g of 2-(1H-Benzotriazole-1-yl)-1,1,3,3-tetramethyluronium hexafluorophosphate (HBTU, 33.3 mmol), and 4.67 mL of Et₃N (33.3 mmol) were added. The mixture was stirred for 3 hrs at room temperature. The reaction mixture was extensively washed with 1N HCl and saturated NaCl. The organic layer was dried to yield 860 mg of DMA3. Both ¹H and ¹³C NMR was used to verify the purity of the final product.

### Example 4

### Synthesis of PDMA-1

20 mL of poly(ethylene glycol) methyl ether methacrylate (EG9ME, Mw=475) was passed through 30 g of Al₂O₃ to remove inhibitors. 2.0 g of DMA-1 (9.0 mmol), 4.7 g of EG9ME (9.8 mmol), and 62 mg of AIBN (0.38 mmol) were dissolved in 15 mL of DMF. Atmospheric oxygen was removed through freeze-pump-thaw treatment three times and replaced with Ar. While under vacuum, the reaction mixture was incubated at 60° C. for 5 hours and precipitated by adding to 50 mL of ethyl ether. After drying, 4 g of a clear sticky solid was obtained (Gel permeation chromatography in concert with light scattering (GPC): M_{w}=430,000, PD=1.8; ¹H NMR: 24 wt % DMA1).

### Example 5

### Synthesis of PDMA-22

987 mg of DMA1 (4.5 mmol), 10 g of N-isopropyl acrylamide (NIPAM, 88.4 mmol), 123 mg of AIBN (0.75 mmol), and 170 mg of cysteamine hydrochloride (1.5 mmol) were dissolved in 50 mL of DMF. Atmospheric oxygen was removed through freeze-pump-thaw treatment three times and replaced with Ar. While under vacuum, the reaction mixture was incubated at 60° C. overnight and precipitated by adding to 450 ml, of ethyl ether. The polymer was filtered and further precipitated in chloroform/ethyl ether. After drying, 4.7 g of white solid was obtained (GPC: M_{w}=81,000, PD=1.1; UV-vis: 11±0.33 wt % DMA1).

### Example 6

### Synthesis of PEU-1

20 g (20 mmol) of PEG-diol (1000 MW) was azeotropically dried with toluene evaporation and dried in a vacuum dessicator overnight. 105 mL of 20% phosgene solution in toluene (200 mmol) was added to PEG dissolved in 100 mL of toluene in a round bottom flask equipped with a condensation flask, an argon inlet, and an outlet to a solution of 20 wt % NaOH in 50% MeOH to trap escaped phosgene. The mixture was stirred in a 55° C. oil bath for four hours with Ar purging, after which the solvent was removed with rotary evaporation. The resulting PEG-dCF was dried with a vacuum pump overnight and used without further purification.

PEG-dCF was dissolved in 50 mL of chloroform and the mixture was kept in an icewater bath. 7.0 g of 4-nitrophenol (50 mmol) and 6.2 mL of triethylamine (440 mmol) in 50 mL of DMF was added dropwise in an Ar atmosphere and the mixture was stirred at room temperature for three hrs. 8.6 g of lysine tetrabutylammonium salt (Lys-TBA, 20 mmol) in 50 mL of DMF was added dropwise over 15 min and the mixture was stirred at room temperature for 24 hrs. 5.7 g of dopamine-HCl (30 mmol), 4.2 mL of triethylamine (30 mmol), 3.2 g of HOBt (24 mmol), and 9.1 g of HBTU (24 mmol) were added and the mixture was further stirred at room temperature for two hours. Insoluble particles were filtered and the filtrate was added to 1.7 L of ethyl ether. After sitting at 4° C. overnight, the supernatant was decanted and the precipitate was dried with a vacuum pump. The crude product was further purified by dialyzing (3,500 MWCO) in deionized water acidified to pH 3.5 with HCl for two days. After freeze drying, 15 g of gooey white product was obtained. (GPC: Mw=200,000; UV-vis: 13±1.3 wt % dopamine)

### Example 7

### Synthesis of PEE-1

8 g of 1000 MW PEG-diol (8 mmol), 2 g of Cbz-Asp-Anh (8 mmol), and 3.1 mg of p-toluenesulfonic salt (0.016 mmol) were dissolved in 50 mL of toluene in a round bottom flask equipped with a Dean-Stark apparatus and a condensation column. While purging with Ar, the mixture was stirred in a 145° C. oil bath for 20 hrs. After cooling to room temperature, toluene was removed by rotoevaporation and the polymer was dried in a vacuum. 23.8 μL of titanium(IV) isopropoxide was added and the mixture was stirred under vacuum (0.5 torr) in a 130° C. oil bath for 18 hrs. 60 mL of chloroform was added and the solution was filtered into 450 mL of ethyl ether. The precipitated polymer was filtered and dried under vacuum to yield 6 g of p(EG1k-CbzAsp) (GPC: Mw=65,000, PD=4.0).

5 g of p(EG1k-CbzAsp) was dissolved in 30 mL of DMF and purged with Ar for 20 min. 10 g of 10 wt % palladium loaded on carbon (Pd/C) was added and 155 mL of formic acid was added dropwise. The mixture was stirred under Ar overnight and Pd/C was filtered and washed with 200 mL of 1N HCl. The filtrate was extracted with DCM and the organic layer was dried over MgSO₄. MgSO₄ was filtered and DCM was reduced to around 50 mL and added to 450 mL of ethyl ether. The resulting polymer was filtered and dried under vacuum to yield 2.1 g of p(EG1k-Asp) (GPC: Mw=41,000, PD=4.4).

2.1 g of p(EG1k-Asp) (1.77 mmol —NH₂) was dissolved in 30 mL of DCM and 15 mL of DMF. 842 mg of N-Boc-DOPA (2.83 mmol), 382 mg of HOBt (2.83 mmol), HBTU (2.83 mmol), and 595 μL of Et₃N (4.25 mmol) were added. The mixture was stirred for 1 hr at room temperature and added to 450 mL ethyl ether. The polymer was further precipitated in cold MeOH and dried in vacuum to yield 1.9 g of PEE-1 (GPC: Mw=33,800, PD=1.3; UV-vis: 7.7±1.3 wt % DOPA).

### Example 8

### Synthesis of PEE-5

50 g of PEG-diol (1,000 MW, 50 mmol) and 200 mL of toluene were stirred in a 3-necked flask equipped with a Dean-Stark apparatus and a condensation column. While purging under Ar, the PEG was dried by evaporating 150 mL of toluene in a 145° C. oil bath. After the temperature of the mixture cooled to room temperature, 100 mL of DCM was added and the polymer solution was submerged in an ice water bath. 17.5 mL of Et₃N (125 mmol) in 60 mL of DCM and 5.7 mL of fumaryl chloride (50 mmol) in 70 mL of DCM were added dropwise and simultaneously over 30 min. The mixture was stirred for 8 hrs at room temperature. Organic salt was filtered out and the filtrate was added to 2.7 L of ethyl ether. After precipitating once more in DCM/ethyl ether, the polymer was dried to yield 45.5 g of p(EG1k-Fum) (GPC: Mw=21,500, PD=3.2).

45 g of p(EG1k-Fum) (41.7 mmol of fumarate vinyl group), 36.2 mL of 3-mercaptopropionic acid (MPA, 417 mmol), and 5.7 g of AIBN were dissolved in 300 mL of DMF. The solution was degassed three times with freeze-pump-thaw cycles. While sealed under vacuum (5 torr), the mixture was stirred in a 60° C. water bath overnight. The resulting polymer was precipitated twice with ethyl ether and dried to yield 41.7 g of p(EG1kf-MPA) (GPC: Mw=14,300, PD=2.3)

41 g of p(EG1kf-MPA) was dissolved in 135 mL of DMF and 270 mL of DCM. 10.5 g of dopamine HCl (55.4 mmol), 7.5 g of HOBt (55.4 mmol), 20.9 g of HBTU (55.4 mmol), and 11.6 mL of Et₃N (83 mmol) were added. The mixture was stirred for 2 hrs at room temperature and then added to 2.5 L of ethyl ether. The polymer was further purified by dialysis using 3500 MWCO dialysis tubing in deionized water for 24 hrs. After lyophilization, 30 g of PEE-5 was obtained (GPC-LS: Mw=21,000, PD=2.0; UV-vis: 9.4±0.91 wt % dopamine).

### Example 9

### Synthesis of PEE-9

4 g of HMPA (30 mmol) and 6 g of PEG-diol (600 MW, 10 mmol) were dissolved in 20 mL of chloroform, 20 mL of THF, and 40 mL of DMF. While stirring in an ice water bath with Ar purging, 4.18 mL of succinyl chloride (38 mmol) in 30 mL of chloroform and 14 mL of Et₃N (100 mmol) in 20 mL of chloroform were added simultaneously and dropwise over 3.5 hrs. The reaction mixture was stirred at room temperature overnight. The insoluble organic salt was filtered out and the filtrate was added to 800 mL of ethyl ether. The precipitate was dried under a vacuum to yield 8 g of p(EG600DMPA-SA) (¹H NMR: HMPA:PEG=3:1).

8 g of p(EG600DMPA-SA) (10 mmol —COOH) was dissolved in 20 mL of chloroform and 10 mL of DMF. 3.8 g of HBTU (26 mmol), 1.35 g of HOBt (10 mmol), 2.8 g of dopamine HCl (15 mmol), and 3.64 mL of Et₃N (26 mmol) were added and the reaction mixture was stirred for an hour. The mixture was added to 400 mL of ethyl ether and the precipitated polymer was further purified by dialyzing using 3500 MWCO dialysis tubing in deionized water for 24 hrs. After lyophilization, 600 mg of PEE-9 was obtained (GPC-LS: Mw=15,000, PD=4.8; UV-vis: 1.0±0.053 μmol dopamine/mg polymer, 16±0.82 wt % dopamine).

### Example 10

### Synthesis of PEA-2

903 mg of Jeffamine ED-2001 (0.95 mmol —NH₂) in 10 mL of THF was reacted with 700 mg of Cbz-DOPA-NCA (1.4 mmol) and 439 mg of Cbz-Lys-NCA (1.41 mmol) for three days. 293 μL of triethylamine (2.1 mmol) was added to the mixture and 105 μL of succinyl chloride (0.95) was added dropwise and stirred overnight. After precipitating the polymer in ethyl ether and drying under a vacuum, 800 mg of solid was obtained. (¹H NMR: 0.6 Cbz-DOPA and 2.2 Cbz-Lys per ED2k)

The dried compound was dissolved in 4 mL of MeOH and Pd (10 wt % in carbon support) was added with Ar purging. 12 mL of 1 N formic acid was added dropwise and the mixture was stirred overnight under Ar atmosphere. 20 mL 1 N HCl was added and Pd/C was removed by filtration. The filtrate was dialyzed in deionized water (3,500 MWCO) for 24 hours. After lyophilization, 80 mg of PEA-2 was obtained. (GPC: Mw=16,000; PD=1.4; UV-vis: 3.6 wt % DOPA)

### Example 11

### Synthesis of GEL-1

3.3 g of DOHA (18.3 mmol) was dissolved in 25 mL of DMSO and 35 mL of 100 mM MES buffer (pH 6.0, 300 mM NaCl) and 3.5 g of EDC (18.3 mmol) and 702 mg of NHS (6.1 mmol) were added. The mixture was stirred at room temperature for 10 min and 10 g of gelatin (75 bloom, Type B, Bovine) was dissolved in 100 mL of 100 mM MES buffer (pH 6.0, 300 mM NaCl) was added. The pH was adjusted to 6.0 with concentrated HCl and the mixture was stirred at room temperature overnight. The mixture was added to dialysis tubing (15,000 MWCO) and dialyzed in deionized water acidified to pH 3.5 for 24 hrs. After lyophilization, 5.1 g of GEL-1 was obtained (UV-vis: 8.4±0.71 DOHA per gelatin chain, 5.9±0.47 wt % DOHA).

### Example 12

### Synthesis of GEL-4

10 g of gelatin (75 bloom, Type B, Bovine) was dissolved in 200 mL of 100 mM MES buffer (pH 6.0, 300 mM NaCl). 2.3 g of cysteamine dihydrochloride (10.2 mmol) was added and stirred until it dissolved. 1.63 g of EDC (8.5 mmol) and 245 mg of NHS (2.1 mmol) were added and the mixture was stirred overnight at room temperature. The pH was raised to 7.5 by adding 1 N NaOH, and 9.44 g of DTT (61.2 mmol) was added. The pH of the solution was increased to 8.5 and the mixture was stirred at room temperature for 24 hrs. The pH was reduced to 3.5 by adding 6 N HCl, and the reaction mixture was dialyzed using 15,000 MWCO dialysis tubing with deionized water acidified to pH 3.5 for 24 hrs. The solution was lyophilized to yield 7.5 g of Gelatin-g-CA (UV-vis: 0.46±0.077 μmol CA/mg polymer or 11±1.8 CA per gelatin chain).

7.5 g of Gelatin-g-CA (3.4 mmol —SH) was dissolved in 100 mL of 12.5 mM acetic acid. 279 mg of AIBN (1.7 mmol) in 20 mL of MeOH and 3.73 g of DMA1 (17 mmol) were added and the mixture was degassed with two cycles of freeze-pump-thaw cycles. While sealed under Ar, the mixture was stirred in an 85° C. oil bath overnight. The mixture was dialyzed using 15,000 MWCO dialysis tubing with deionized water acidified to pH 3.5 for 24 hrs. The solution was lyophilized to yield 4.5 g of GEL-4 (UV-vis: 54 wt % DMA1, 128±56 DMA1 per gelatin chain).

### Example 13

### Synthesis of GEL-5

9 g of gelatin (75 bloom, Type B, Bovine) was dissolved in 100 mL of deionized water. 150 mg of AIBN (0.91 mmol) in 1 mL of DMF was added and the mixture was degassed with Ar bubbling for 20 min. The mixture was stirred in a 50° C. water bath for 10 min. 1.0 g of DMA1 (4.6 mmol) in 10 mL of MeOH was added dropwise and the mixture was stirred at 60° C. overnight. The reaction mixture was added to 750 mL of acetone and the precipitate was further purified by dialyzing in deionized water (using 3,500 MWCO dialysis tubing) for 24 hrs. The solution was precipitated in acetone and the polymer was dried in a vacuum desiccator to yield 5.0 g of GEL-5 (UV-vis: 17 wt % DMA1, 21±2.3 DMA1 per gelatin chain).

Examples from Ser. No. 12/099,254

It should be understood that throughout the specification different abbreviations may be used for certain of the compounds. For example, C-(PEG-DOPA-Boc)₄ equals PEG10k-(D)₄, C-(PEG-DOPA₄)₄ equals PEG10k-(D₄)₄, C-(PEG-DOPA₃-Lys₂)₄ equals PEG10k-(DL)₄, C-(PEG-DOHA)₄ equals PEG10k-(DH)₄, C-(PEG-DMu)₄ equals PEG10k-(DMu)₄ and C-PEG-DMe)₄ equals PEG10k-(DMe)₄.

Detailed descriptions of the synthesis, curing, and adhesive experimentation for these adhesive polymers is as follow:

Synthesis of C-(PEG-DOPA-Boc)₄, C-(PEG-DOHA)₄ (QuadraSeal-DH), and C-(PEG-DMe)₄

C-(PEG-DOPA-Boc)₄ was synthesized by dissolving branched PEG-NH₂ (MW=10,000 Da) in a 2:1 DCM:DMF to make a 45 mg/mL polymer solution. 1.6 molar equivalent (relative to —NH₂) of N-Boc-DOPA, 1-hydroxybenzotriazole hydrate, and O-(Benzotriazol-1-yl)-N,N,N′,N′-tetramethyluronium hexafluorophosphate were then added. 2.4 equivalent of triethylamine was finally added and the mixture was stirred at room temperature for 1 hour. Polymer purification was performed by precipitation in diethyl ether and cold methanol.

C-(PEG-DOHA)₄ (m=56) was synthesized as described above using 3,4-dihydroxy-hydrocinnamic acid (DOHA) instead of N-Boc-DOPA. The resulting polymer was purified by precipitation in diethyl ether followed by dialysis with deionized water (3500 MWCO) for 24 hours. Subsequent lyophilization yielded C-(PEG-DOHA)₄ (m=56).

C-(PEG-DOHA)₄ (m=113) was synthesized as described above using 3,4-dihydroxy-hydrocinnamic acid (DOHA) instead of N-Boc-DOPA and PEG-NH₂ (MW=20,000 Da). The resulting polymer was purified by precipitation in diethyl ether followed by dialysis with deionized water (3500 MWCO) for 24 hours. Subsequent lyophilization yielded C-(PEG-DOHA)₄ (m=113).

C-(PEG-DMe)₄ was synthesized by first reacting branched PEG-OH (MW=10,000 Da) with 5 times excess (relative to —OH) of succinic anhydride and catalytic amount of pyridine in chloroform at 70° C. for 18 hrs. After repeated precipitation in chloroform/ethyl ether, the resulting C-(PEG-SA)₄ is further reacted with 1.6 equivalent of dopamine hydrochloride using similar procedures as described above. The resulting polymer was purified by precipitation in diethyl ether followed by dialysis with deionized water acidified to pH 3.5 with hydrochloric acid (3500 MWCO) for 24 hours. Subsequent lyophilization yielded C-(PEG-DMe)₄.

Synthesis of C-(PEG-DOPA₄)₄ (QuadraSeal-D4) and C-(PEG-DOPA₃-Lys₂)₄.

N-carboxyanhydrides (NCAs) of DOPA (diacetyl-DOPA-NCA) and lysine (Fmoc-Lys-NCA) were prepared by following literature procedures [1,2]. Four-armed PEG-NH₂ (MW=10,000 Da) was first dried by azeotropic evaporation with benzene and dried in a desiccator for ≧3 h. Ring-opening polymerization of NCA was performed by dissolving 4-armed PEG-NH₂ in anhydrous THF at 100 mg/mL and purged with argon. Six molar excess (relative to —NH₂) of diacectyl-DOPA-NCA with or without Fmoc-Lys-NCA was added neat. The reaction mixture was stirred at room temperature for 5 d with a dry tube outlet. The peptide-modified block copolymers were purified in succession with ethyl ether three times. Peptide-coupled PEG was dissolved in anhydrous DMF at a concentration of 50 mg/mL and bubbled with Ar for 10 min. Pyridine was added to make a 5% solution and stirred for 15 min with Ar bubbling. The mixture was rotary evaporated to remove excess pyridine and precipitated in ethyl ether. The crude polymer was further purified by dialyzing the compound in deionized water (MWCO 3500) for 4 hours and lyophilized to yield the final products.

Synthesis of PEG10k-(DMu)₄:

10 g of 4-armed PEG-OH (10,000 MW; 4 mmol —OH) was dried with azeotropic evaporation with toluene and dried in a vacuum desiccator. To PEG in 90 mL of toluene was added 10.6 mL of phosgene solution (20% phosgene in toluene; 20 mmol phosgene) and the mixture was stirred for 4 hrs in a 55° C. oil bath, with Ar purging and a NaOH solution trap in the outlet to trap escaped phosgene. The mixture was evaporated and dried with vacuum for overnight. 65 mL of chloroform and 691 mg of N-hydroxysuccinimide (6 mmol) were added to chloroformate-activated PEG and 672 mL of triethylamine (4.8 mmol) in 10 mL of chloroform was added dropwise. The mixture was stirred under Ar for 4 hrs. 1.52 g of dopamine-HCl (8 mmol), 2.24 mL of triethylamine (8 mmol), and 25 mL of DMF was added, and the polymer mixture was stirred at room temperature for overnight. 100 mL of chloroform was added and the solution was washed successively with 100 mL each of 12 mM HCl, saturated NaCl solution, and H₂O. The organic layer was dried over MgSO₄. MgSO₄ was removed by filtration and the filtrate was reduced to around 50 mL and added to 450 mL of diethyl ether. The precipitate was filter and dried to yield 8.96 g of PEG10k-(DMu)₄.

### ADDITIONAL EXAMPLES

### Example

### Synthesis of Medhesive-023

26 g (26 mmol) of PEG-diol (1000 MW) was azeotropically dried with toluene evaporation and dried in a vacuum dessicator overnight. 136 mL of 20% phosgene solution in toluene (260 mmol) was added to PEG dissolved in 130 mL of toluene in a round bottom flask equipped with a condensation flask, an argon inlet, and an outlet to a solution of 20 wt % NaOH in 50% MeOH to trap escaped phosgene. The mixture was stirred in a 55° C. oil bath for three hours with Ar purging, after which the solvent was removed with rotary evaporation. The resulting PEG-dCF was dried with a vacuum pump overnight and used without further purification.

PEG-dCF was dissolved in 50 mL chloroform, to which a mixture of 7.48 g of NHS (65 mmol), 9.1 mL of triethylamine (65 mmol) and 50 mL of DMF was added dropwise. The mixture was stirred at room temperature for 3 hrs under Argon. 11.2 g Lysine-TBA (26 mmol) was dissolved in 50 mL DMF and added dropwise over a period of 15 minutes. The mixture was stirred at room temperature for overnight. 9.86 g of HBTU (26 mmol), 3.51 g of HOBt (26 mmol) and 5.46 mL triethylamine (39 mmol) were added to the reaction mixture and stirred for 10 minutes, followed by the addition of 13.7 g Boc-Lys-TBA (26 mmol) in 25 mL DMF and stirred for an additional 30 minutes. Next, 7.4 g dopamine-HCl (39 mmol) and 14.8 g HBTU (39 mmol) were added to the flask and stirred for 1 hour, and the mixture was added to 1.6 L of diethyl ether. The precipitate was collected with vacuum filtration and dried. The polymer was dissolved in 170 mL chloroform and 250 mL of 4M HCl in dioxane were added. After 15 minutes of stirring, the solvents were removed via rotary evaporation and the polymer was dried under vacuum. The crude polymer was further purified using dialysis with 3500 MWCO tubes in 7 L of water (acidified to pH 3.5) for 2 days. Lyophilization of the polymer solution yielded 16.6 g of Medhesive-023. ¹H NMR confirmed chemical structure; UV-vis: 0.54±0.026 μmol dopamine/mg polymer, 8.2±0.40 wt % dopamine.

### Example

### Synthesis of Medhesive-024 Also Referred to as PEEU-1

18.9 g (18.9 mmol) of PEG-diol (1000 MW) was azeotropically dried with toluene evaporation and dried in a vacuum dessicator overnight. 100 mL of 20% phosgene solution in toluene (189 mmol) was added to PEG dissolved in 100 mL of toluene in a round bottom flask equipped with a condensation flask, an argon inlet, and an outlet to a solution of 20 wt % NaOH in 50% MeOH to trap escaped phosgene. The mixture was stirred in a 55° C. oil bath for three hours with Ar purging, after which the solvent was removed with rotary evaporation. The resulting PEG-dCF was dried with a vacuum pump overnight and used without further purification.

PEG-dCF was dissolved in 50 mL of chloroform and the mixture was kept in an icewater bath. 5.46 g of NHS (47.4 mmol) and 5.84 mL of triethylamine (41.7 mmol) in 20 mL of DMF was added dropwise to the PEG solution. And the mixture was stirred at room temperature for 3 hrs. Polycaprolactone diglycine touluene sulfonic salt (PCL-(GlyTSA)₂) PCL=1250 Da) in 50 mL of chloroform was added. 2.03 g of Lysine (13.9 mmol) was freeze dried with 9.26 mL of 1.5 M tetrabutyl ammonium hydroxide and the resulting Lys-TBA salt in 50 mL DMF was added. The mixture was stirred at room temperature for 24 hrs. 5.39 g of dopamine HCl (28.4 mmol), 8.61 g of HBTU (22.7 mmol), 3.07 g of HOBt (22.7 mmol) and 3.98 mL triethylamine (28.4 mmol) were added. Stirred at room temperature for 1 hr and the mixture was added to 2 L ethyl ether. The precipitate was collected with vacuum filtration and the polymer was further dialyzed with 3500 MWCO tubes in 8 L of water (acidified to pH 3.5) for 2 days. Lyophilization of the polymer solution yielded 12 g of Medhesive-024. ¹H NMR indicated 62 wt % PEG, 25 wt % PCL, 7 wt % lysine, and 6 wt % dopamine.

### Example

### Synthesis of Medhesive-026

36 g (18.9 mmol) of PEG-PPG-PEG (1900 MW) was azeotropically dried with toluene evaporation and dried in a vacuum dessicator overnight. 100 mL of 20% phosgene solution in toluene (189 mmol) was added to PEG dissolved in 100 mL of toluene in a round bottom flask equipped with a condensation flask, an argon inlet, and an outlet to a solution of 20 wt % NaOH in 50% MeOH to trap escaped phosgene. The mixture was stirred in a 55° C. oil bath for three hours with Ar purging, after which the solvent was removed with rotary evaporation. The resulting PEG-dCF was dried with a vacuum pump overnight and used without further purification.

A solution containing 5.46 g of NHS (67.4 mmol) in 50 mL of DMF and 5.84 mL of triethylamine (41.7 mmol) was added dropwise over 10 minutes to the ClOC—O-PEG-PPC-PEG-O—COCl dissolved in 50 mL of chloroform in an ice bath. The resulting mixture was stirred at room temperature for 3 hrs with argon purging. 9.3 g of Lysine (37.8 mmol) was freeze dried with 25.2 mL of 1.5 M tetrabutyl ammonium hydroxide and Lys-TBA salt (18.9 mmol) in 50 mL DMF was added over 5 minutes. The mixture was stirred at room temperature for 24 hours. 5.39 g of dopamine HCl (28.4 mmol), 8.11 g of HBTU (22.7 mmol), 3.07 g of HOBt (22.7 mmol) and 3.98 mL triethylamine (28.4 mmol) were added along with 50 mL chloroform. The solution was stirred at room temperature for 1 hr and the mixture filtered using coarse filter paper into 2.0 L of ethyl ether and placed in 4° C. for overnight. The precipitate was collected with vacuum filtration and dried under vacuum. The polymer was dissolved in 200 mL methanol and dialyzed with 3500 MWCO tubes in 7 L of water (acidified to pH 3.5) for 2 days. Lyophilization of the polymer solution yielded 19 g of Medhesive-026. ¹H NMR confirmed chemical structure and showed ˜70% coupling of dopamine; UV-vis: 0.354±0.031 μmol dopamine/mg polymer, 4.8±0.42 wt % dopamine.

### Example

### Synthesis of Medhesive-027

22.7 g (37.8 mmol) of PEG-diol (600 MW) was azeotropically dried with toluene evaporation and dried in a vacuum dessicator overnight. PEG600 was dissolved in 200 mL toluene and 200 mL (378 mmol) phosgene solution was added in a round bottom flask equipped with a condensation flask, an argon inlet, and an outlet to a solution of 20 wt % NaOH in 50% MeOH to trap escaped phosgene. The mixture was stirred in a 55° C. oil bath for three hours with Ar purging, after which the solvent was removed with rotary evaporation and the polymer was dried for 24 hours under vacuum to yield PEG600-dCF.

1.9 g (1.9 mmol) PEG-diol (1000 MW) was azeotropically dried with toluene evaporation and dried in a vacuum dessicator overnight. Dissolved PEG1000 in 10 ml, toluene and added 10 mL (19 mmol) phosgene solution. The 1k MW PEG solution was heated to 60 C in a round bottom flask equipped with a condensation flask, an argon inlet, and an outlet to a solution of 20 wt % NaOH in 50% MeOH to trap escaped phosgene and stirred for 3 hours. The toluene was removed with rotary evaporation and further dried with vacuum to yield PEG1000-dCF.

7.6 g (3.8 mmol) of PCL-diol (2000 MW), 624.5 mg (8.32 mmol) Glycine, and 1.58 g (8.32 mmol) pTSA-H2O were dissolved in 50 mL toluene. The reaction mixture was refluxed at 140-150° C. for overnight. The resulting PCL(Gly-TSA)₂ was cooled to room temperature and any solvents were removed with rotary evaporation and further dried under vacuum. PCL(Gly-TSA)₂ was dissolved in 50 mL chloroform and 5 mL DMF and 1.17 mL (8.32 mmol) triethylamine was added. The reaction flask was submerged in an ice water bath while stirring. Next, PEG1k-dCF in 30 mL chloroform was added dropwise while Ar purging. This mixture was stirred overnight at room temperature to form [EG1kCL2kG].

10.9 g (94.6 mmol) NHS was dissolved in 50 mL DMF, 11.7 mL (83.2 mmol) triethylamine and 70 mL chloroform. This NHS/triethylamine mixture was added dropwise to PEG600-dCF dissolved in 150 mL chloroform stirring in an ice water bath. The reaction mixture was stirred at room temperature overnight to form PEG600(NHS)₂.

5.25 g (35.9 mmol) Lysine was dissolved in 23.9 mL (35.9 mmol) 1.5M TBA and 30 mL water and freeze-dried. 8.84 g BOC-Lys (3.59 mmol) was dissolved in 23.9 mL (35.9 mmol) 1.5M TBA and 40 mL water and freeze-dried to yield Boc-Lys-TBA.

[EG1kCL2kG] was added dropwise to PEG600(NHS)₂ over a period of 10 minutes. Lys-TBA was dissolved in 75 mL DMF and added dropwise. The reaction mixture was stirred for 24 hours. Next 4.85 g HOBt (35.9 mmol), 13.6 g HBTU (35.9 mmol), and 20 mL triethylamine (35.9 mmol) were added and the mixture stirred for 10 minutes, followed by the addition of BOC-Lys-TBA in 50 mL DMF. Stirred for an additional 30 minutes. Added 20.5 g (108 mmol) dopamine-HCl, 9.72 g (71.9 mmol) HOBT and 29.3 (71.9 mmol) HBTU and stirred for 2 hours and added the reaction mixture to 2.4 L diethyl ether. The precipitate was collected by decanting the supernatant and drying under vacuum. The polymer was dissolved in 250 mL chloroform and added 375 mL 4M HCl in dioxane, stirring for 15 minutes. Used rotary evaporation to remove solvents. The crude polymer was purified using dialyis with 15,000 MWCO tubes in 8 L of water for 2 days, using water acidified to pH 3.5 on the second day. Lyophilization of the polymer solution yielded 22 g of Medhesive-027. ¹H NMR confirmed chemical structure showing a molar ratio of dopamine:PEG600:PCL2k:Lys:PEG1k=1:1.41:0.15:1.61:0.07. UV-vis: 0.81±0.014 μmol dopamine/mg polymer, 12±0.21 wt % dopamine.

### Example

### Synthesis of Medhesive-030

22.7 g (37.8 mmol) of PEG-diol (600 MW) was azeotropically dried with toluene evaporation and dried in a vacuum dessicator overnight. 200 mL of 20% phosgene solution in toluene (378 mmol) was added to PEG dissolved in 100 mL of toluene in a round bottom flask equipped with a condensation flask, an argon inlet, and an outlet to a solution of 20 wt % NaOH in 50% MeOH to trap escaped phosgene. The mixture was stirred in a 55° C. oil bath for three hours with Ar purging, after which the solvent was removed with rotary evaporation. The resulting PEG-dCF was dried with a vacuum pump overnight and used without further purification.

To PEG-dCF was added 10.9 g of NHS (94.6 mmol) and 100 mL of chloroform and 11.7 mL of triethylamine (83.2 mmol) in 25 mL of DMF was added dropwise to the PEG solution. And the mixture was stirred at room temperature for 3 hrs. 9.3 g of Lysine (37.8 mmol) was freeze dried with 25.2 mL of 1.5 M tetrabutyl ammonium hydroxide and the resulting Lys-TBA salt in 75 mL DMF was added. The mixture was stirred at room temperature for overnight. 10.4 g of dopamine HCl (54.6 mmol), 17.2 g of HBTU (45.5 mmol), 6.10 g of HOBt (45.4 mmol) and 7.6 mL triethylamine (54.6 mmol) were added. Stirred at room temperature for 2 hrs and the mixture was added to 1.4 L of ethyl ether. The precipitate was collected with vacuum filtration and the polymer was further dialyzed with 3500 MWCO tubes in 7 L of water (acidified to pH 3.5) for 2 days. Lyophilization of the polymer solution yielded 14 g of Medhesive-030. Dopamine modification was repeated to afford 100% coupling of dopamine to the polymer. ¹H NMR confirmed chemical structure; UV-vis: 1.1±0.037 μmol dopamine/mg polymer, 16±0.57 wt % dopamine; GPC: Mw=13,000, PD=1.8.

### Example

### Synthesis of Medhesive-038

37.8 g (18.9 mmol) of PEG-diol (2000 MW) was azeotropically dried with toluene evaporation and dried in a vacuum dessicator overnight. 100 mL of 20% phosgene solution in toluene (189 mmol) was added to PEG dissolved in 100 mL of toluene in a round bottom flask equipped with a condensation flask, an argon inlet, and an outlet to a solution of 20 wt % NaOH in 50% MeOH to trap escaped phosgene. The mixture was stirred in a 55° C. oil bath for three hours with Ar purging, after which the solvent was removed with rotary evaporation. The resulting PEG-dCF was dried with a vacuum pump overnight and used without further purification.

To PEG-dCF was added 5.45 g of NHS (47.3 mmol) and 200 mL of chloroform and 5.85 mL of triethylamine (47.3 mmol) in 80 mL of DMF was added dropwise to the PEG solution. And the mixture was stirred at room temperature for 4 hrs. 2.76 g of Lysine (18.9 mmol) was freeze dried with 18.9 mL of 1M tetrabutyl ammonium hydroxide and the resulting Lys-TBA salt in 40 mL DMF was added. The mixture was stirred at room temperature for overnight. The mixture was added to 800 mL of diethyl ether. The precipitate was collected via vacuum filtration and dried. Dissolved 10 g of the dried precipitate (4.12 mmol) in 44 mL of chloroform and 22 mL of DMF and added to 1.17 g of Dopamine HCl (6.18 mmol), 668 mg of HOBt (4.94 mmol), 1.87 g of HBTU (4.94 mmol), and 1.04 mL of triethylamine (7.42 mmol). Stirred at room temperature for 1 hr and the mixture was added to 400 mL of ethyl ether. The precipitate was collected with vacuum filtration and the polymer was further dialyzed with 15000 MWCO tubes in 3.5 L of water (acidified to pH 3.5) for 2 days. Lyophilization of the polymer solution yielded 14 g of Medhesive-038. Dopamine modification was repeated to afford 100% coupling of dopamine to the polymer. ¹H NMR confirmed chemical structure; UV-vis: 0.40±0.014 μmol dopamine/mg polymer, 6.2±0.22 wt % dopamine; GPC: Mw=25,700, PD=1.7.

### Example

### Synthesis of Medhesive-043

22.7 g (37.8 mmol) of PEG-diol (600 MW) was azeotropically dried with toluene evaporation and dried in a vacuum dessicator overnight. 200 mL of 20% phosgene solution in toluene (378 mmol) was added to PEG dissolved in 100 mL of toluene in a round bottom flask equipped with a condensation flask, an argon inlet, and an outlet to a solution of 20 wt % NaOH in 50% MeOH to trap escaped phosgene. The mixture was stirred in a 55° C. oil bath for three hours with Ar purging, after which the solvent was removed with rotary evaporation. The resulting PEG-dCF was dried with a vacuum pump overnight and used without further purification.

To PEG-dCF was added 10.9 g of NHS (94.6 mmol) and 100 mL of chloroform and 11.7 mL of triethylamine (83.2 mmol) in 25 mL of DMF was added dropwise to the PEG solution. And the mixture was stirred at room temperature for 3 hrs. 5.53 g of Lysine (37.8 mmol) was dissolved in 30 mL DMF and added dropwise and stirred at room temperature for overnight. The mixture was added to 800 mL of diethyl ether. The precipitate was collected via vacuum filtration and dried.

Dissolved the dried precipitate (37.8 mmol) in 150 mL of chloroform and 75 mL of DMF to 5.1 g of HOBt (37.8 mmol), 14.3 g of HBTU (37.8 mmol), 9.31 g of Boc-Lysine (37.8 mmol) and 15.9 mL of triethylamine (113 mmol). The mixture is stirred at room temperature for 1 hour. Added 5.1 g of HOBt (37.8 mmol), 14.3 g of HBTU (37.8 mmol), and 14.3 g of Dopamine HCl (75.4 mmol) and allowed to stir for 1 hour at room temperature. The mixture was added to 1400 mL of diethyl ether. The precipitate was collected via vacuum filtration and dried. Dissolved the dried precipitate in 160 mL of chloroform and 250 mL of 6M HCl Dioxane and stirred for 3 hours at room temperature. The solvent was evaporated under vacuum with NaOH trap. Added 300 mL of toluene and evaporated under vacuum. 400 mL of water is added and vacuum filtered the precipitate. The crude product was further purified through dialysis (3500 MWCO) in deionized H₂O for 4 hours, deionized water (acidified to pH 3.5) for 40 hrs and deionized water for 4 more hours. After lyophilization, 14.0 g of Medhesive-068 was obtained. ¹H NMR confirmed chemical structure; UV-vis: 0.756±0.068 μmmol dopamine/mg polymer, 12±1.0 wt % dopamine.
1. Waite, J. H., Nature's underwater adhesive specialist. Int. J. Adhes. Adhes., 1987. 7(1): p. 9-14.
2. Yamamoto, H., Marine adhesive proteins and some biotechnological applications. Biotechnology and Genetic Engineering Reviews, 1996. 13: p. 133-65.
3. Yu, M., J. Hwang, and T. J. Deming, Role of L-3,4-dihydroxyphenylanine in mussel adhesive proteins. Journal of American Chemical Society, 1999. 121(24): p. 5825-5826.
4. Deming, T. J., M. Yu, and J. Hwang, Mechanical studies of adhesion and crosslinkning in marine adhesive protein analogs. Polymeric Materials: Science and Engineering, 1999. 80: p. 471-472.
5. Waite, J. H., Mussel beards: A coming of Age. Chemistry and Industry, 1991. 2 Sep.: p. 607-611.
6. Waite, J. H. and S. O. Andersen, 3,4-Dihydroxyphenylalanine in an insoluble shell protein of Mytilus edulis. Biochimica et Biophysica Acta, 1978. 541(1): p. 107-14.
7. Pardo, J., et al., Purification of adhesive proteins from mussels. Protein Expr Purif, 1990. 1(2): p. 147-50.
8. Papov, V. V., et al., Hydroxyarginine-containing polyphenolic proteins in the adhesive plaques of the marine mussel Mytilus edulis. Journal of Biological Chemistry, 1995. 270(34): p. 20183-92.
9. Maugh, K. J., et al., Recombinant bioadhesive proteins of marine animals and their use in adhesive compositions, in Genex Corp. 1988: USA. p. 124.
10. Strausberg, R. L., et al., Development of a microbial system for production of mussel adhesive protein, in Adhesives from Renewable Resources. 1989. p. 453-464.
11. Filpula, D. R., et al., Structural and functional repetition in a marine mussel adhesive protein. Biotechnol. Prog., 1990. 6(3): p. 171-7.
12. Yu, M. and T. J. Deming, Synthetic polypeptide mimics of marine adhesives. Macromolecules, 1998. 31(15): p. 4739-45.
13. Yamamoto, H., Adhesive studies of synthetic polypeptides: a model for marine adhesive proteins. J. Adhes. Sci. Technol., 1987. 1(2): p. 177-83.
14. Yamamoto, H., et al., Insolubilizing and adhesive studies of water-soluble synthetic model proteins. Int. J. Biol. Macromol., 1990. 12(5): p. 305-10.
15. Tatehata, H., et al., Model polypeptide of mussel adhesive protein. I. Synthesis and adhesive studies of sequential polypeptides (X-Tyr-Lys)n and (Y-Lys)n. Journal of Applied Polymer Science, 2000. 76(6): p. 929-937.
16. Strausberg, R. L. and R. P. Link, Protein-based medical adhesives. Trends in Biotechnology, 1990. 8(2): p. 53-7.
17. Young, G. A. and D. J. Crisp, Marine Animals and Adhesion, in Adhesion 6. Barking, K. W. Allen, Editor. 1982, Applied Science Publishers, Ltd.: England.
18. Ninan, L., et al., Adhesive strength of marine mussel extracts on porcine skin. Biomaterials, 2003. 24(22): p. 4091-9.
19. Schnurrer, J. and C.-M. Lehr, Mucoadhesive properties of the mussel adhesive protein. International Journal of Pharmaceutics, 1996. 141(1,2): p. 251-256.
20. Lee, B. P., et al., Synthesis of 3,4-Dihydroxyphenylalanine (DOPA) Containing Monomers and Their Copolymerization with PEG-Diacrylate to from Hydrogels. Journal of Biomaterials Science, Polymer Edition, 2004. 15: p. 449-464.
21. Lee, B. P., J. L. Dalsin, and P. B. Messersmith, Synthesis and Gelation of DOPA-Modified Poly(ethylene glycol) Hydrogels. Biomacromolecules, 2002. 3(5): p. 1038-47.
22. Lee, B. P., et al., Rapid Photocurable of Amphiphilic Block Copolymers Hydrogels with High DOPA Contents. Maclomolecules, 2006. 39: p. 1740-48.
23. Huang, K., et al., Synthesis and Characterization of Self-Assembling Block Copolymers Containing Bioadhesive End Groups. Biomacromolecules, 2002. 3(2): p. 397-406.
24. Dalsin, J. L., et al., Mussel Adhesive Protein Mimetic Polymers for the Preparation of Nonfouling Surfaces. Journal of American Chemical Society, 2003. 125: p. 4253-4258.
25. Dalsin, J. L., L. Lin, and P. B. Messersmith, Antifouling performance of poly(ethylene glycol) anchored onto surfaces by mussel adhesive protein mimetic peptides. Polymeric Materials Science and Engineering, 2004. 90: p. 247-248.
26. Dalsin, J. L., et al., Protein Resistance of Titanium Oxide Surfaces Modified by Biologically Inspired mPEG-DOPA. Langmuir, 2005. 21(2): p. 640-646.
27. Statz, A. R., et al., New Peptidomimetic Polymers for Antifouling Surfaces. Journal of the American Chemical Society, 2005. 127(22): p. 7972-7973.
28. Fan, X., L. Lin, and P. B. Messersmith, Surface-initiated polymerization from TiO₂ nanoparticle surfaces through a biomimetic initiator: A new route toward polymer-matrix nanocomposites. Composites Science and Technology, 2006. 66: p. 1195-1201.
29. Dossot, M., et al., Role of phenolic derivatives in photopolymerization of an acrylate coating. Journal of Applied Polymer Science, 2000. 78(12): p. 2061-2074.
30. Khudyakov, I. V., et al., Kinetics of Photopolymerization of Acrylates with Functionality of 1-6. Ind. Eng. Chem. Res., 1999. 38: p. 3353-3359.
31. Sichel, G., et al., Relationship between melanin content and superoxide dismutase (SOD) activity in the liver of various species of animals. Cell Biochem. Funct, 1987. 5(2): p. 123-8.
32. Waite, J. H. and X. Qin, Polyphosphoprotein from the Adhesive Pads of Mytilus edulis. Biochemistry, 2001. 40(9): p. 2887-93.
33. Long, J. R., et al., A peptide that inhibits hydroxyapatite growth is in an extended conformation on the crystal surface. Proceedings of the National Academy of Sciences of the United States of America, 1998. 95(21): p. 12083-12087.
34. Meisel, H. and C. Olieman, Estimation of calcium-binding constants of casein phosphopeptides by capillary zone electrophoresis. Anal. Chim. Acta, 1998. 372(1-2): p. 291-297.
35. Lu, G., D. Wu, and R. Fu, Studies on the synthesis and antibacterial activities of polymeric quaternary ammonium salts from dim ethylaminoethyl methacrylate. Reactive & Functional Polymers, 2007. 67(4): p. 355-366.
36. Li, Z., et al., Two-Level Antibacterial Coating with Both Release-Killing and Contact-Killing Capabilities. Langmuir 2006. 22(24): p. 9820-9823.
37. Sun, Q., et al., Improved antifouling property of zwitterionic ultrafiltration membrane composed of acrylonitrile and sulfobetaine copolymer. Journal of Membrane Science, 2006. 285(1+2): p. 299-305.
38. Kitano, H., et al., Resistance of zwitterionic telomers accumulated on metal surfaces against nonspecific adsorption of proteins. Journal of Colloid and Interface Science, 2005. 282(2): p. 340-348.
39. Hajjaji, N., et al., Effect of N-alkylbetaines on the corrosion of iron in 1 M hydrochloric acid solution. Corrosion, 1993. 49(4): p. 326-34.
40. Morgan, D. M. L., V. L. Larvin, and J. D. Pearson, Biochemical characterization of polycation-induced cytotoxicity to human vascular endothelial cells. Journal of Cell Science, 1989. 94(3): p. 553-9.
41. Fischer, D., et al., In vitro cytotoxicity testing of polycations: influence of polymer structure on cell viability and hemolysis. Biomaterials 2003. 24(7): p. 1121-1131.
42. Zekorn, T. D., et al., Biocompatibility and immunology in the encapsulation of islets of Langerhans (bioartificial pancreas). Int J Artif Organs, 1996. 19(4): p. 251-7.
43. Ishihara, M., et al., Photocrosslinkable chitosan as a dressing for wound occlusion and accelerator in healing process. Biomaterials, 2002. 23(3): p. 833-40.
44. Huin-Amargier, C., et al., New physically and chemically crosslinked hyaluronate (HA)-based hydrogels for cartilage repair. Journal of Biomedical Materials Research, Part A, 2006. 76A(2): p. 416-424.
45. Stevens, P. V., Food Australia, 1992. 44(7): p. 320-324.
46. Ikada, Y., Tissue adhesives, in Wound Closure Biomaterials and Devices, C. C. Chu, J. A. von Fraunhofer, and H. P. Greisler, Editors. 1997, CRC Press, Inc.: Boca Raton, Fla. p. 317-346.
47. Sierra, D. and R. Saltz, Surgical Adhesives and Sealants: Current Technology and Applications. 1996, Lancaster, Pa.: Technomic Publishing Company, Inc.
48. Donkerwolcke, M., F. Burny, and D. Muster, Tissues and bone adhesives—historical aspects. Biomaterials 1998. 19 p. 1461-1466.
49. Rzepecki, L. M., K. M. Hansen, and J. H. Waite, Bioadhesives: dopa and phenolic proteins as component of organic composite materials, in Principles of Cell Adhesion. 1995, CRC Press. p. 107-142.
50. Spotnitz, W. D., History of tissue adhesive, in Surgical Adhesives and Sealants: Current Technology and Applications, D. H. Sierra and R. Saltz, Editors. 1996, Technomic Publishing Co. Inc.: Lancaster, Pa. p. 3-11.
51. ASTM-F2392, Standard Test Method for Burst Strength of Surgical Sealants 2004.
52. Lee, B. P., J. L. Dalsin, and P. B. Messersmith, Synthetic Polymer Mimics Of Mussel Adhesive Proteins for Medical Applications, in Biological Adheisves, A. M. Smith and J. A. Callow, Editors. 2006, Springer-Verlag. p. 257-278.
53. Benedek, I., End-Uses of Pressure Sensitive Products, in Developments In Pressure-Sensitive Products, I. Benedek, Editor. 2006, CRC Press: Boca Raton, Fla. p. 539-596.
54. Creton, C., Pressure-sensitive adhesives: an introductory course. MRS Bulletin, 2003. 28(6): p. 434-439.
55. Lucast, D. H., Adhesive considerations for developing stick-to-skin products. Adhesives Age 2000. 43(10): p. 38-39.
56. Venkatraman, S. and R. Gale, Skin adhesives and skin adhesion. 1. Transdermal drug delivery systems. Biomaterials, 1998. 19(13): p. 1119-36.
57. Feldstein, M. M., N. A. Plate, and G. W. Cleary, Molecular design of hydrophilic pressure-sensitive adhesives for medical applications, in Developments In Pressure-Sensitive Products, I. Benedek, Editor. 2006, CRC Press: Boca Raton, Fla. p. 473-503.
58. Skelhorne, G. and H. Munro, Hydrogel Adhesive for Wound-Care Applications. Medical Device Technology, 2002: p. 19-23.
59. Chalykh, A. A., et al., Pressure-Sensitive Adhesion in the Blends of Poly(N-Vinyl Pyrrolidone) and Poly(Ethylene Glycol) of Disparate Chain Lengths. The Journal of Adhesion, 2002 78(8): p. 667-694.
60. Ruibal, R. and V. Ernst, The structure of the digital setae of lizards. J. Morphology, 1965. 117: p. 271-293.
61. Geim, A. K., et al., Microfabricated adhesive mimicking gecko foot-hair. Nat. Materials, 2003. 2: p. 461-463.
62. Northen, M. T. and K. L. Turner, A batch fabricated biomimetic dry adhesive. Nanotechnology 2005. 16: p. 1159-1166.
63. Sitti, M. and R. Fearing, Synthetic gecko foot-hair micro/nano-structures as dry adhesives. J. Adhes. Sci. Technol., 2003. 17: p. 1055-1073.
64. Yurdumakan, B., et al., Synthetic gecko foot-hairs from multiwalled carbon nanotubes. Chem. Commun., 2005. 30: p. 3799-3801.
65. Peressadko, A. and S. N. Gorb, When less is more: Experimental evidence for tenacity enhancement by division of contact area. J. Adhesion, 2004. 80: p. 1-5.
66. Crosby, A. J., M. Hageman, and A. Duncan, Controlling polymer adhesion with “Pancakes”. Langmuir 2005. 21: p. 11738-11743.
67. Northen, M. T. and K. L. Turner, Meso-scale adhesion testing of integrated micro- and nano-scale structures. Sensors and Actuators A, 2006. 130-131: p. 583-587.
68. Huber, G., et al., Evidence for capillary contributions to gecko adhesion from single spatula nanomechanical measurements. Proc. Nat. Acad. Sci. USA, 2005. 102: p. 16293-16296.
69. Sun, W., et al., The nature of the gecko lizard adhesive force. Biophys. J., 2005. 89: p. L14-16.
70. Wisniewski, N. and M. Reichert, Methods for reducing biosensor membrane biofouling. Colloids Surf B Biointerfaces, 2000 18(3-4): p. 197-219.
71. Gu, J. D., et al., The role of microbial biofilms in deterioration of space station candidate materials. Int. Biodeterior Biodegradaton, 1998. 41(1): p. 25-33.
72. Harris, J. M., Introduction to biotechnical and biomedical applications of poly(ethylene glycol), in Poly(ethylene glycol) chemistry: biotechnical and biomedical applications, J. M. Harris, Editor. 1992, Plenum Press: New York. p. 1-14.
73. Ryu, D. Y., et al., A Generalized Approach to the Modification of Solid Surfaces Science 2005. 308(5719): p. 236-239.
74. Ratner, B. D., Titanium in Medicine: Material Science, Surface Science, Engineering, Biological Responses and Medical Applications, ed. D. M. Brunette, et al. 2000, Heidelberg: Springer-Verlag.
75. Leonard, E. F., V. T. Turitto, and L. Vroman, Blood in contact with natural and artificial surfaces. New York Academy of Sciences, 1987. 516: p. 688.
76. Mukkamala, R., A. M. Kushner, and C. R. Bertozzi, Hydrogel polymers from alkylthio acrylates for biomedical applications. Polymer Gels: Fundamentals and Applications, 2003. 833: p. 163-174.
77. Bruinsma, G. M., H. C. van der Mei, and H. J. Busscher, Bacterial adhesion to surface hydrophilic and hydrophobic contact lenses. Biomaterials 2001. 22(24): p. 3217-3224.
78. Zawada, J., A-dec, Inc. 2005.
79. Kingshott, P., H. Thissen, and H. J. Griesser, Effects of cloud-point grafting, chain length, and density of PEG layers on competitive adsorption of ocular proteins. Biomaterials, 2002. 23(9): p. 2043-2056.
   List of PEG-Based Monomers Used in this Patent Application

| Monomer | Abbreviation | R₁₀ | R₁₂ |
|---|---|---|---|
| Poly(ethylene glycol) methyl ether methacrylate (Mn~300) | EG4ME | 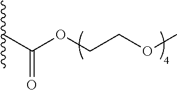 | —CH₃ |
| Poly(ethylene glycol) methyl ether methacrylate (Mn~475) | EG9ME | 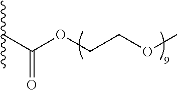 | —CH₃ |
| Poly(ethylene glycol) methyl ether acrylamide (Mn~680) | EG12AA | 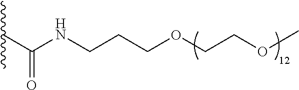 | —H |
| Poly(ethylene glycol) methyl ether methacrylamide (Mn~1085) | EG22MA | 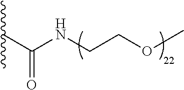 | —CH₃ |

List of Neutral Hydrophilic Monomers Used in this Patent Application

| Monomer | Abbreviation | R₁₀ | R₁₂ |
|---|---|---|---|
| Acrylamide | AAm | 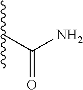 | —H |
| N-Acryloylmorpholine | NAM | 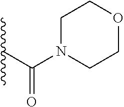 | —H |
| 2-Hydroxyethyl methacrylate | HEMA | 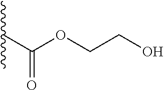 | —CH₃ |
| N-Isopropylacrylamide | NIPAM | 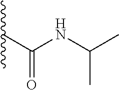 | —H |
| 2-Methoxyethyl acrylate | MEA | 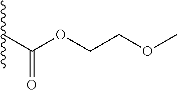 | —H |
| [3- (Methacryloylamino) propyl]dimethyl(3- sulfopropyl)ammonium | SBMA | 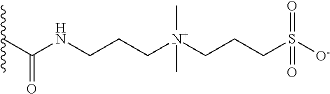 | —CH₃ |
| 1-Vinyl-2-pyrrolidone | VP | 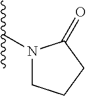 | —H |

List of Basic Monomers Used in this Patent Application

| | Abbrev- | | |
|---|---|---|---|
| Monomer | iation | R₁₀ | R₁₂ |
| (3-Acryl- amido- propyl) trimethyl- ammonium | APTA | 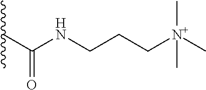 | —H |
| Allyl- amine | AA | 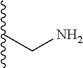 | —H |
| 1,4-Di- amino- butane meth- acryl- amide | DABMA | 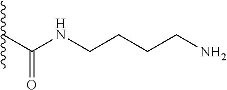 | —CH₃ |

List of Acidic Monomers Used in this Patent Application

| Monomer | Abbreviation | R₁₀ | R₁₂ |
|---|---|---|---|
| 2-Acryl- amido- 2-methyl- 1-propane- sulfonic acid | AMPS | 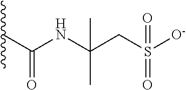 | —H |
| Ethylene glycol meth- acrylate phosphate | EGMP | 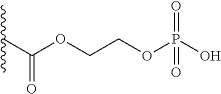 | —CH₃ |

Hydrophobic Monomer Used in this Patent Application

| Monomer | Abbreviation | R₁₀ | R₁₂ |
|---|---|---|---|
| 2,2,2-Trifluoroethyl methacrylate | TFEM | 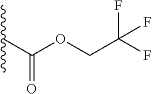 | —CH₃ |

List of PEG-Based Polymers Prepared from AIBN-Initiated Polymerization

| | | Monomer | Monomer:AIBN | | | | |
|---|---|---|---|---|---|---|---|
| | Reaction | Feed Molar | Feed Molar | Reaction | | | DMA |
| Polymer | Solvent | Ratio | Ratio | Time (Hrs) | M_{w} | PD | wt % |
| PDMA-1 | DMF | 1:1 | 50:1 | 5 | 430,000 | 1.8 | 24 |
| | | DMA1:EG9ME | | | | | |
| PDMA-2 | DMF | 1:9 | 98:1 | 18 | >10⁶ | — | 4.1 |
| | | DMA1:EG9ME | | | | | |
| PDMA-3 | DMF | 1:1 | 50:1 | 17 | 790,000 | 4.1 | 32 |
| | | DMA1:EG4ME | | | | | |
| PDMA-4 | DMF | 1:3 | 50:1 | 16 | 9,500 | 1.7 | 12 |
| | | DMA1:EG12AA | | | | | |
| PDMA-5 | DMF | 1:1 | 40:1 | 18 | — | — | 26 |
| | | DMA3:EG9ME | | | | | |

List of Water Soluble Polymers Prepared from AIBN-Initiated Polymerization

| | | Monomer | Monomer:AIBN | | | | |
|---|---|---|---|---|---|---|---|
| | Reaction | Feed Molar | Feed Molar | Reaction | | | DMA |
| Polymer | Solvent | Ratio | Ratio | Time (Hrs) | M_{w} | PD | wt % |
| PDMA-6 | 0.5M | 1:8 | 77:1 | 18 | 220,000 | 1.2 | 8.6 |
| | NaCl | DMA1:SBMA | | | | | |
| PDMA-7 | DMF | 1:20 | 250:1 | 16 | 250,000 | 3.5 | 4.5 |
| | | DMA1:NAM | | | | | |
| PDMA-8 | DMF | 1:20 | 250:1 | 16 | — | — | 8.5 |
| | | DMA2:NAM | | | | | |
| PDMA-9 | DMF | 1:10 | 250:1 | 16 | — | — | 18 |
| | | DMA1:Am | | | | | |
| PDMA-10 | Water/ | 1:10 | 250:1 | 16 | — | — | 23 |
| | Methanol | DMA1:Am | | | | | |

List of Water Insoluble, Hydrophilic Polymers Prepared from AIBN-Initiated Polymerization

| | | Monomer | Monomer:AIBN | | | | |
|---|---|---|---|---|---|---|---|
| | Reaction | Feed Molar | Feed Molar | Reaction | | | DMA |
| Polymer | Solvent | Ratio | Ratio | Time (Hrs) | M_{w} | PD | wt % |
| PDMA-11 | DMF | 1:3 | 100:1 | 18 | — | — | 27 |
| | | DMA1:HEMA | | | | | |
| PDMA-12 | DMF | 1:8 | 100:1 | 18 | 250,000 | 1.7 | 21 |
| | | DMA1:MEA | | | | | |

Hydrophobic Polymer Prepared from AIBN-Initiated Polymerization

| | Reaction | Monomer | Monomer:AIBN | Reaction | | | |
|---|---|---|---|---|---|---|---|
| Polymer | Solvent | Feed Molar Ratio | Feed Molar Ratio | Time (Hrs) | M_{w} | PD | DMA wt % |
| DMA-13 | DMF | 1:25 | 105:1 | 17 | — | — | 2.8 |
| | | DMA1:TFME | | | | | |

List of 3-Component Polymers Prepared from AIBN-Initiated Polymerization

| | | Monomer | Monomer:AIBN | Reaction | | | |
|---|---|---|---|---|---|---|---|
| | Reaction | Feed Molar | Feed Molar | Time | | | DMA |
| Polymer | Solvent | Ratio | Ratio | (Hrs) | M_{w} | PD | wt % |
| PDMA-14 | DMF | 1:1:1 | 75:1 | 17 | 108 | 1.2 | 13 |
| | | DMA1:DABMA:EG9ME | | | | | |
| PDMA-15 | DMF | 1:2:4 | 70:1 | 4 | 132,000 | 1.2 | 7.0 |
| | | DMA:AA:EG9ME | | | (67 wt %) | | |
| | | | | | 61,000 | 1.3 | |
| | | | | | (33 wt %)* | | |
| PDMA-16 | DMF | 1:1:1 | 75:1 | 16 | 78,000 | 1.0 | 18 |
| | | DMA1:APTA:EG9ME | | | | | |
| PDMA-17 | DMF | 1:1:25 | 84:1 | 16 | — | — | 6.8 |
| | | DMA1:APTA:NAM | | | | | |
| PDMA-18 | DMF | 2:1:4 | 35:1 | 4 | 82,000 | 1.9 | 14 |
| | | DMA1:AMPS:EG4ME | | | | | |
| PDMA-19 | DMF | 1:1:1 | 75:1 | 16 | 97,000 | 2.0 | 17 |
| | | DMA1:AMPS:EG9ME | | | | | |
| PDMA-20 | Water/ | 2:1:20 | 245:1 | 3 | — | — | 19 |
| | Methanol | DMA1:AMPS:Am | | | | | |
| PDMA-21 | DMF | 1:1:8 | 67:1 | 16 | 81,000 | 1.2 | 3.9 |
| | | DMA1:EGMP:EG9ME | | | | | |

*Bimodal molecular weight distribution

### List of Polymers Prepared Using CA as the Chain Transfer Agent

| | | Monomer | Monomer:AIBN | Reaction | | | |
|---|---|---|---|---|---|---|---|
| | Reaction | Feed Molar | Feed Molar | Time | | | DMA |
| Polymer | Solvent | Ratio | Ratio | (Hrs) | M_{w} | PD | wt % |
| PDMA-22 | DMF | 1:20 | 125:2:1 | 18 | 81,000 | 1.1 | 11 |
| | | DMA1:NIPAM | Monomer:CA:AIBN | | | | |
| PDMA-23 | DMF | 1:3 | 95:12:1 | 18 | 5,700 | 2.1 | 31 |
| | | DMA1:NAM | Monomer:CA:AIBN | | | | |
| PD MA-24 | DMF | 1:1 | 27:1.3:1 | 18 | 106,000 | 1.7 | 5.0 |
| | | DMA1:EG22MA | Monomer:CA:AIBN | | (58 wt %) | | |
| | | | | | 7,600 | 1.6 | |
| | | | | | (42 wt %)* | | |

*Bimodal molecular weight distribution

### Hydrophilic Prepolymers Used in Chain Extension Reaction

| | | Chemical Structure | |
|---|---|---|---|
| | | In Poly(Ether Urethane)/ | |
| | | Poly(Ether Ester | |
| Prepolymer | Abbreviation | Urethane) | In Poly(Ether Ester) |
| Polyethylene glycol 600 MW | EG600 | 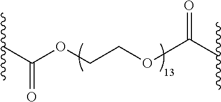 | 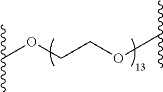 |
| Polyethylene glycol 1000 MW | EG1k | 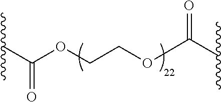 | 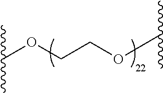 |
| Polyethylene glycol 8000 MW | EG8k | 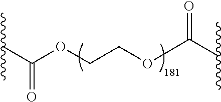 | 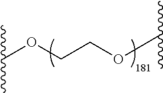 |
| Branched, 4- Armed Polyethylene glycol 8000 MW | EG10kb | — | 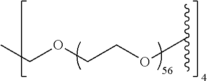 |

### Hydrophobic Prepolymers Used in Chain Extension Reaction

| Prepolymer | Abbreviation | Chemical Structure |
|---|---|---|
| Polycaprolactone 2000 MW | CL2k | 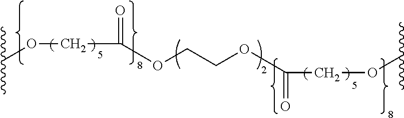 |
| Polycaprolactone Bis-Glycine 1000 MW | CL1kG | 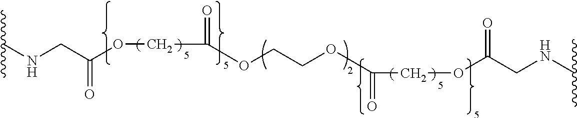 |
| Polycaprolactone Bis-Glycine 2000 MW | CL2kG | 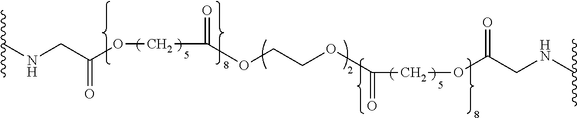 |

### Amphiphilic Prepolymers Used in Chain Extension Reaction

| Prepolymer | Abbreviation | Chemical Structure |
|---|---|---|
| PEG-PPG-PEG 1900 MW | F2k | 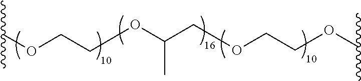 |
| PEG-PPG-PEG 8350 MW | F68 | 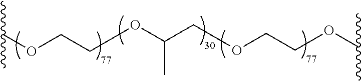 |
| PPG-PEG-PPG 1900 MW | ED2k | 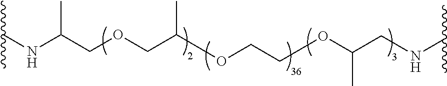 |

### Chain Extender Used in Chain Extension Reaction

| Prepolymer | Abbreviation | Chemical Structure |
|---|---|---|
| Lysine | Lys | 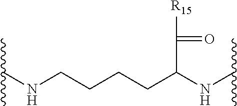 |
| Aspartic Acid | Asp | 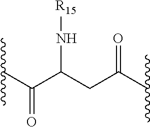 |
| 2,2-Bis(Hydroxy- methyl) Propionic Acid | HMPA | 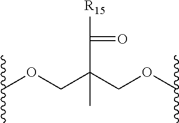 |
| Fumarate coupled with 3-Mercapto- propionic Acid | fMPA | 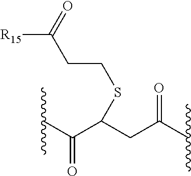 |
| Fumarate coupled with Cysteamine | fCA | 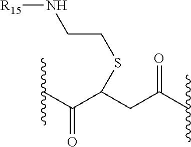 |
| Succinic Acid | SA | 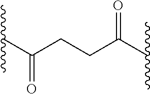 |

R₁₅=DHPD or R₁₅═H for lysine with free —NH₂ where specified.

### Poly(Ether Urethane)

| Poly- | Backbone | DHPD | Weight % | | | |
|---|---|---|---|---|---|---|
| mer | Composition | Type | DHPD | M_{w} | PD | Note |
| PEU- | 89 wt % | Dopamine | 13 | 200,000 | 2.0 | |
| 1 | EG1k; | | | | | |
| | 11 wt % Lys | | | | | |
| PEU- | 89 wt% | Dopamine | 8.2 | 140,000 | 1.2 | Addition |
| 2 | EG1k; | | | | | al |
| | 11 wt % Lys | | | | | Lysine |
| PEU- | 94 wt % F2k; | Dopamine | 4.8 | — | — | |
| 3 | 6 wt % Lys | | | | | |
| PEU- | 29 wt % | Dopamine | 6.4 | — | — | |
| 4 | EG1k; | | | | | |
| | 65 wt % | | | | | |

### Poly(Ether Ester)

| | Backbone | DHPD | Weight | | | |
|---|---|---|---|---|---|---|
| Polymer | Composition | Type | % | M_{w} | PD | Note |
| PEE-1 | 91 wt % | DOPA | 7.7 | 34,000 | 1.3 | |
| | EG1k; | | | | | |
| PEE-2 | 86 wt % | DOHA | 21 | 18,000 | 4.2 | |
| | EG600; | | | | | |
| PEE-3 | 91 wt % | DOHA | 13 | 11,000 | 2.9 | |
| | EG1k; | | | | | |
| PEE-4 | 85 wt % | Dopamine | 9.4 | 21,000 | 2.0 | |
| | EG1k; | | | | | |
| PEE-5 | 71 wt % | Dopamine | 6.8 | 77% | 2.7 | |
| | EG1k; | | | 17,000* | 1.2 | |
| PEE-6 | 92 wt % F2k; | Dopamine | 3.0 | 79% | 1.8 | |
| | 8 wt % fMPA | | | 27,000* | 1.4 | |
| PEE-7 | 64 wt % | DOHA | 6.1 | 63,000 | 1.7 | |
| | EG1k; | | | | | |
| PEE-8 | 68 wt % | Dopamine | 16 | 15,000 | 4.8 | |
| | EG600; | | | | | |

*Bimodal molecular weight distribution.

### Poly(Ether Amide)

| | Backbone | DHPD | Weight % | | | |
|---|---|---|---|---|---|---|
| Polymer | Composition | Type | DHPD | M_{w} | PD | Note |
| PEA-1 | 93 wt % | DOHA | 5.9 | — | — | |
| | ED2k; | | | | | |
| | 7 wt % fCA | | | | | |
| PEA-2 | 80 wt % | DOPA | 2.9 | 16,000 | 1.4 | Lysine |
| | ED2k; | | | | | with free |
| | 12 wt % Lys; | | | | | —NH₂ |

### Poly(Ether Ester Urethane)

| | Backbone | DHPD | Weight | | | |
|---|---|---|---|---|---|---|
| Polymer | Composition | Type | % | M_{w} | PD | Note |
| PEEU-1 | 66 wt % | Dopamine | 6.0 | — | — | |
| | EG1k; | | | | | |
| | 26 wt % | | | | | |
| PEEU-2 | 63 wt % | Dopamine | 10 | — | — | |
| | EG1k; | | | | | |
| | 18 wt % | | | | | |
| PEEU-3 | 64 wt % | Dopamine | 12 | — | — | Addition |
| | EG600; | | | | | al Lysine |
| | 21 wt % | | | | | with free |

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

1. A blend of a polymer and a multihydroxyphenyl (DHPD) functionalized polymer (DHPp), wherein the DHPp comprises the formula: 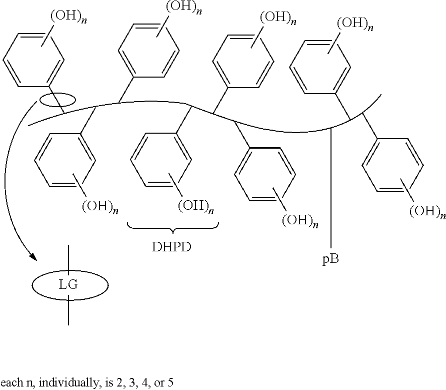
wherein LG is an optional linking group or linker, DHPD is a multihydroxyphenyl group, each n, individually, is 2, 3, 4 or 5, and pB is a polymeric backbone.

2. The blend of claim 1, further comprising an oxidant.

3. The blend of claim 2, wherein the oxidant is formulated with the coating.

4. The blend of claim 2, wherein the oxidant is applied to the coating.

5. The blend of claim 1, further comprising a support, wherein the support is a film, a mesh, a membrane, a nonwoven or a prosthetic.

6. The blend of claim 4, further comprising a support, wherein the support is a film, a mesh, a membrane, a nonwoven or a prosthetic.

7. The blend of claim 1, wherein the construct is hydrated.

8. The blend of claim 4, wherein the construct is hydrated.

9. The blend of claim 1, wherein the DHPD comprises at least about 1 to 100 weight percent of the DHPp.

10. The blend of claim 1, wherein the DHPD comprises at least about 2 to about 65 weight percent of the DHPp.

11. The blend of claim 1, wherein the DHPD comprises at least about 3 to about 55 weight percent of the DHPp.

12. The blend of claim 1, wherein the pB consists essentially of a polyalkylene oxide.

13. The blend of claim 1, wherein the pB is substantially a homopolymer.

14. The blend of claim 1, wherein the pB is substantially a copolymer.

15. The blend of claim 1, wherein the DHPD is a 3,4 dihydroxy phenyl.

16. The blend of claim 1, wherein the DHPD's are linked to the pB via a urethane, urea, amide, ester, carbonate or carbon-carbon bond.

17. The blend of claim 1, wherein the DHPp polymer comprises the formula: 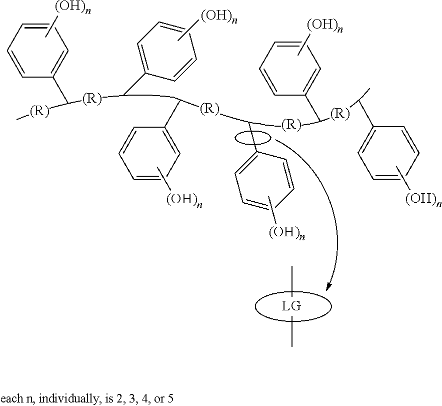
wherein R is a monomer or prepolymer linked or polymerized to form pB, pB is a polymeric backbone, LG is an optional linking group or linker and each n, individually, is 2, 3, 4 or 5.

18. The blend of claim 17, wherein R is a polyether, a polyester, a polyamide, a polyacrylate a polymethacrylate or a polyalkyl.

19. The blend of claim 17, wherein the DHPD is a 3,4 dihydroxy phenyl.

20. The blend of claim 17, wherein the DHPD's are linked to the pB via a urethane, urea, amide, ester, carbonate or carbon-carbon bond.

21. The blend of claim 1, wherein the DHPp polymer comprises the formula:
CA-[Z-PA-(L)ₐ-(DHPD)_{b}-(AA)_{c}-PG]ₙ
wherein
CA is a central atom that is carbon;
each Z, independently, is a C1 to a C6 linear or branched, substituted or unsubstituted alkyl group or a bond;
each PA, independently, is a substantially poly(alkylene oxide) polyether or derivative thereof;
each L, independently, optionally, is a linker or is a linking group selected from amide, ester, urea, carbonate or urethane linking groups;
each DHPD, independently is a multihydroxy phenyl derivative;
each AA independently, optionally, is an amino acid moiety,
each PG, independently, is an optional protecting group, and if the protecting group is absent, each PG is replaced by a hydrogen atom;
“a” has a value of 0 when L is a linking group or a value of 1 when L is a linker;
“b” has a value of one or more;
“c” has a value in the range of from 0 to about 20; and
“n” has a value of 4.

22. The blend of claim 21, wherein each DHPD is either dopamine, 3,4-dihydroxyphenyl alanine, 2-(3,4-dihydroxyphenyl)ethanol, or 3,4-dihydroxyhydrocinnamic acid.

23. The blend of claim 21, wherein the linking group is an amide, urea or urethane.

24. The blend of claim 1, wherein the DHPp polymer comprises the formula:
CA-[Z-PA-(L)ₐ-(DHPD)_{b}-(AA)_{c}-PG]ₙ
wherein
CA is a central atom selected from carbon, oxygen, sulfur, nitrogen, or a secondary amine;
each Z, independently is a C1 to a C6 linear or branched, substituted or unsubstituted alkyl group or a bond;
each PA, independently, is a substantially poly(alkylene oxide) polyether or derivative thereof;
each L, independently, optionally, is a linker or is a linking group selected from amide, ester, urea, carbonate or urethane linking groups;
each DHPD, independently, is a multihydroxy phenyl derivative;
each AA, independently, optionally, is an amino acid moiety,
each PG, independently, is an optional protecting group, and if the protecting group is absent, each PG is replaced by a hydrogen atom;
“a” has a value of 0 when L is a linking group or a value of 1 when L is a linker;
“b” has a value of one or more;
“c” has a value in the range of from 0 to about 20; and
“n” has a value from 3 to 15.

25. The blend of claim 1, wherein the polymer is present in a range of about 1 to about 50 percent by weight.

26. The blend of claim 1, wherein the polymer is present in a range of about 1 to about 30 percent by weight.

27. A bioadhesive construct comprising:
a support;
a first coating comprising a blend of claim 1 and
a second coating coated onto the first coating, wherein the second coating comprises a multihydroxyphenyl (DHPD) functionalized polymer (DHPp) of claim 1.

28. A bioadhesive construct comprising:
a support;
a first coating comprising a blend of claim 1; and
a second coating coated onto the first coating, wherein the second coating comprises a second blend, wherein the first and second blend may be the same or different.

29. A bioadhesive construct comprising:
a support;
a first coating comprising a first multihydroxyphenyl (DHPD) functionalized polymer (DHPp) of claim 1; and
a second coating coated onto the first coating, wherein the second coating comprises a second multihydroxyphenyl (DHPD) functionalized polymer (DHPp) of claim 1, wherein the first and second DHPp can be the same or different.

30. A method to reduce bacterial growth on a substrate surface, comprising the step of coating a multihydroxyphenyl (DHPD) functionalized polymer (DHPp) of claim 1 or blends thereof onto the surface of the substrate.
